(19) United States
(12) Patent Application Publication
(10) Pub. No.: US 2025/0244573 A1
(43) Pub. Date: Jul. 31, 2025

(54) RETINAL PROJECTION IMAGE DISPLAY DEVICE

(71) Applicants: Shu TANAKA, Osaka (JP); Yoshifumi SUDOH, Kanagawa (JP); Masahiro ITOH, Kanagawa (JP)

(72) Inventors: Shu TANAKA, Osaka (JP); Yoshifumi SUDOH, Kanagawa (JP); Masahiro ITOH, Kanagawa (JP)

(21) Appl. No.: 19/015,689

(22) Filed: Jan. 10, 2025

(30) Foreign Application Priority Data
Jan. 31, 2024 (JP) 2024-013115

(51) Int. Cl. G02B 27/00; G02B 26/08; G02B 26/10; G02B 27/01; G02B 27/10; G02B 27/30

(52) U.S. Cl. CPC G02B 27/0081; G02B 26/0858; G02B 26/101; G02B 27/0093; G02B 27/0103; G02B 27/0172; G02B 27/0179; G02B 27/1066; G02B 27/30; G02B 2027/0107; G02B 2027/013; G02B 2027/0174; G02B 2027/0187

(57) ABSTRACT

A retina projection image display device includes a light source to emit light; an optical scanner to scan the light emitted from the light source, to form an image with the scanned light; an eyepiece optical system to guide an exit pupil of the light scanned by the optical scanner to an eyeball; and a variable optical system between the light source and the optical scanner. The variable optical system includes a light collimator to convert the light emitted from the light source into collimated light which is directed to the optical scanner; and a movable mirror with a variable tilt to change a reflection angle of the light emitted from the light source to the optical scanner to change an incident position of the light emitted from the light source onto the optical scanner to shift the exit pupil.

### CROSS-REFERENCE TO RELATED APPLICATION

This patent application is based on and claims priority pursuant to 35 U.S.C. § 119(a) to Japanese Patent Application No. 2024-013115, filed on Jan. 31, 2024, in the Japan Patent Office, the entire disclosure of which is hereby incorporated by reference herein.

### BACKGROUND

### Technical Field

The present disclosure relates to a retinal projection image display device and an optometric device.

### Related Art

A retinal projection display device is known, which projects images onto the wearer's retina, allowing the wearer to see the images.

### SUMMARY

The present disclosure described herein provides a retina projection image display device which includes a light source to emit light; an optical scanner to scan the light emitted from the light source, to form an image with the scanned light; an eyepiece optical system to guide an exit pupil of the light scanned by the optical scanner to an eyeball; and a variable optical system between the light source and the optical scanner. The variable optical system includes a light collimator to convert the light emitted from the light source into collimated light which is directed to the optical scanner; and a movable mirror with a variable tilt to change a reflection angle of the light emitted from the light source to the optical scanner to change an incident position of the light emitted from the light source onto the optical scanner to shift the exit pupil.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic top view of the overall configuration of a retinal projection image display device;

FIG. 2 is a schematic top view of an optical scanner included in the retinal projection image display device of FIG. 1;

FIG. 3 is a schematic top view of a movable mirror included in a variable optical system of the retinal projection image display device in FIG. 1;

FIG. 4 is a block diagram of a hardware configuration of a controller included in the retinal projection image display device of FIG. 1;

FIG. 5 is a block diagram of a functional configuration of the controller included in the retinal projection image display device of FIG. 1;

FIG. 6 is a schematic diagram illustrating an overview of the movement operation of the exit pupil in the retinal projection image display device of FIG. 1;

FIG. 7 is a schematic diagram of the details of the movement operation of the exit pupil in the retinal projection image display device of FIG. 1;

FIG. 8 is a schematic diagram of the details of the movement operation of the exit pupil in the retinal projection image display device of FIG. 1;

FIG. 9 is a schematic diagram of the details of the movement operation of the exit pupil in the retinal projection image display device of FIG. 1;

FIG. 10 is a schematic diagram illustrating the operation of the retinal projection image display device in FIG. 1;

FIG. 11 is a schematic top view of a retinal projection image display device;

FIG. 12 is a schematic diagram illustrating the movement of the exit pupil in the retinal projection image display device of FIG. 11; and

FIG. 13 is a flowchart of a process of moving an exit pupil.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, a device that moves the exit pupil can be miniaturized.

Referring to the drawings, a retinal projection image display device and an optometric device are described in detail according to embodiments of the present disclosure. The embodiments described below illustrate a retinal projection image display device and an optometric device for embodying the technical concept of this embodiment, but are not limited to these examples.

The dimensions, materials, shapes, relative arrangements, and so forth, of components described in the embodiments of the disclosure are not intended to limit the scope of the embodiments of the disclosure thereto, and are intended to be examples unless otherwise specifically indicated. The sizes, positional relationship, and so forth, of members illustrated in the drawings may be exaggerated for clarity of description. In the following description, identical names and reference signs represent identical or equivalent members, and detailed description thereof is appropriately omitted.

In the following description, the arrangement and configuration of each component are described using one of the XYZ orthogonal coordinate system, the αβγ orthogonal coordinate system, and the abc orthogonal coordinate system for easier understanding of the description. The three axes of each of the XYZ orthogonal coordinate system, the αβγ orthogonal coordinate system, and the abc orthogonal coordinate system are orthogonal to each other.

In the XYZ orthogonal coordinate system, a direction in which the X-axis extends is referred to as an “X direction”, a direction in which the Y-axis extends is referred to as a “Y direction”, and a direction in which the Z-axis extends is referred to as a “Z direction”. A direction in which the arrow indicating the X-axis is headed is referred to as a +X direction, and a direction opposite to the +X direction is referred to as a −X direction. A direction in which the arrow indicating the Y-axis is headed is referred to as a +Y direction, and a direction opposite to the +Y direction is referred to as a −Y direction. A direction in which the arrow indicating the Z-axis is headed is referred to as a +Z direction, and a direction opposite to the +Z direction is referred to as a −Z direction. In the present disclosure, a top view refers to a view of an object as viewed in the +Y direction.

In the αβγ orthogonal coordinate system, a direction in which the a-axis extends is referred to as an “α-direction”, a direction in which the β-axis extends is referred to as a “β-direction”, and a direction in which the γ-axis extends is referred to as a “γ-direction”. A direction in which the arrow indicating the α-axis is headed is referred to as a +α-direction, and a direction opposite to the +α-direction is referred to as a −α-direction. A direction in which the arrow indicating the β-axis is headed is referred to as a +β-direction, and a direction opposite to the +β-direction is referred to as a −β-direction. A direction in which the arrow indicating the γ-axis is headed is referred to as a +γ-direction, and a direction opposite to the +γ-direction is referred to as a −γ-direction.

In the abc orthogonal coordinate system, a direction in which the a-axis extends is referred to as an “a-direction”, a direction in which the b-axis extends is referred to as a “b-direction”, and a direction in which the c-axis extends is referred to as a “c-direction”. A direction in which the arrow indicating the a-axis is headed is referred to as a +a-direction, and a direction opposite to the +a-direction is referred to as a −a-direction. A direction in which the arrow indicating the b-axis is headed is referred to as a +b-direction, and a direction opposite to the +b-direction is referred to as a −b-direction. A direction in which the arrow indicating the c-axis is headed is referred to as a +c-direction, and a direction opposite to the +c-direction is referred to as a −c-direction.

However, these merely describe the relationship of relative positions, orientations, directions, and so forth, and may not match the relationship in practical use. These directions are irrelevant to the direction of gravity.

The term “image” in the present disclosure and claims includes not only a still image but also a moving image. The moving image may be referred to as a video. In the terms of the present specification and claims, “match” does not require perfect match, and allows for errors within the range considered acceptable for assembly or processing errors. Similarly, “parallel” does not require perfect parallelism, and allows for errors within the range considered acceptable for assembly or processing errors.

### Configuration of Retinal Projection Image Display

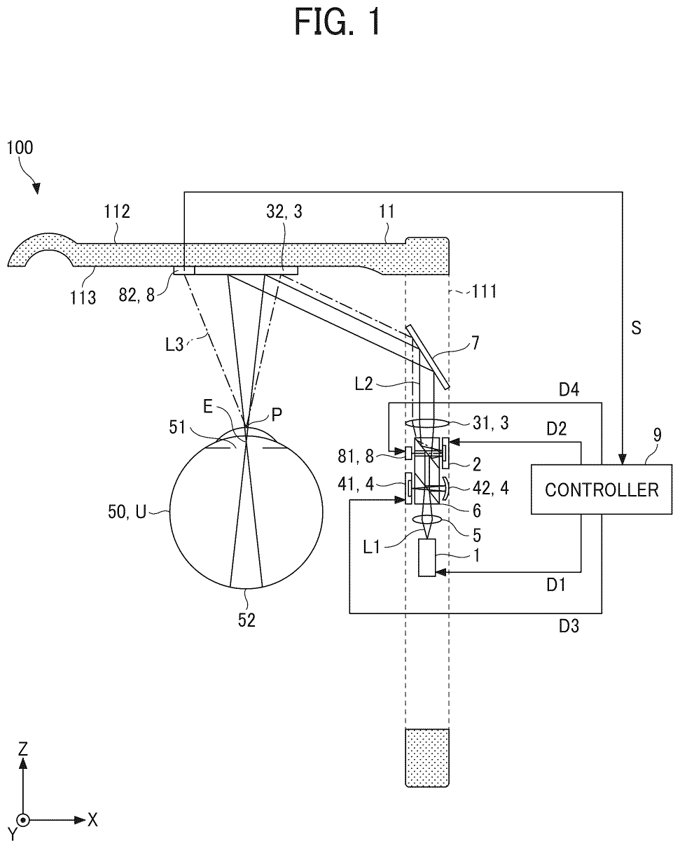

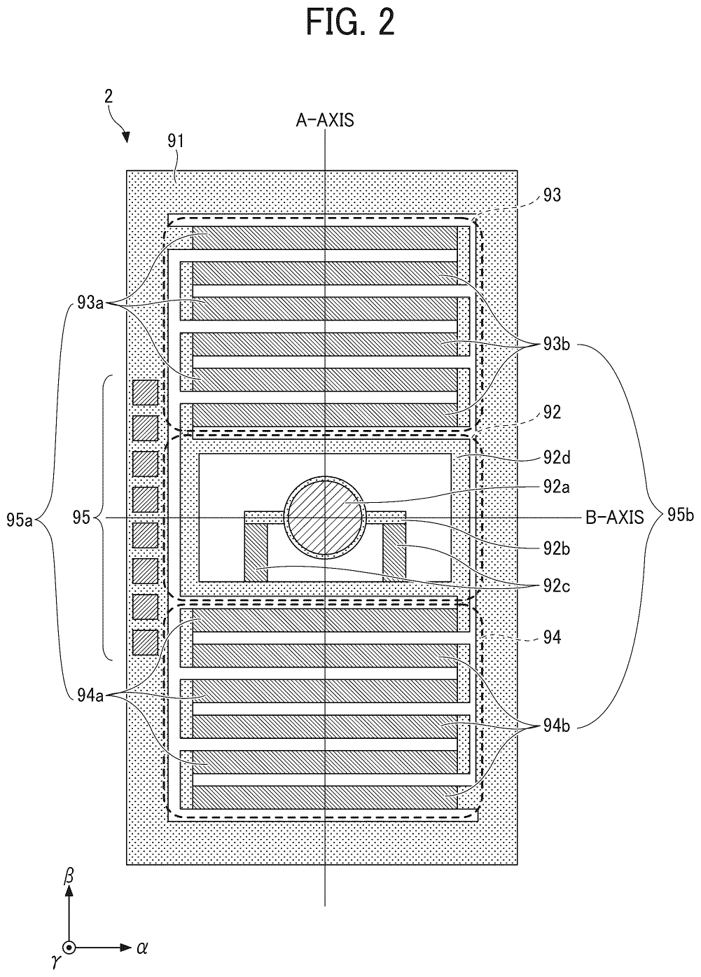

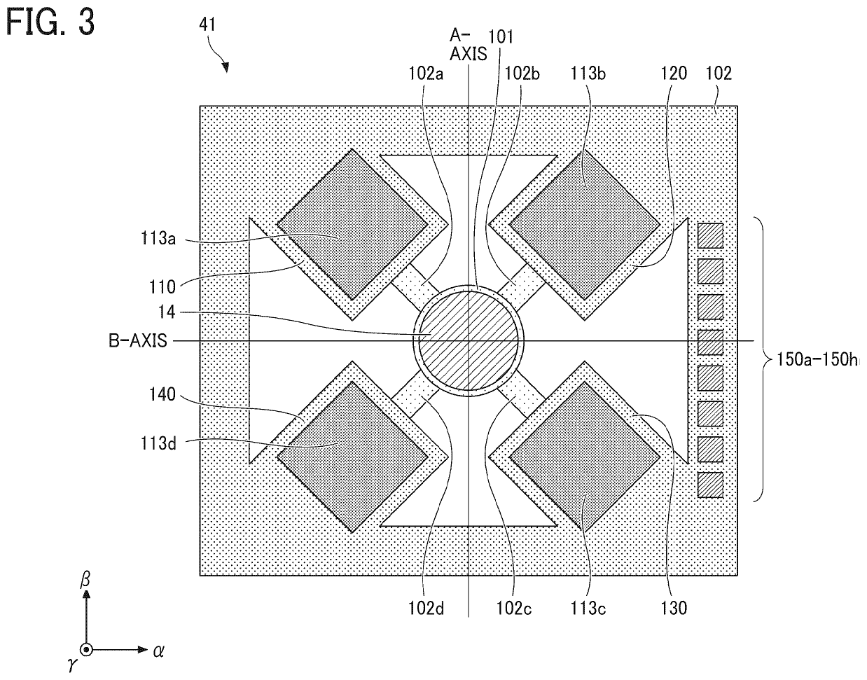

A retinal projection image display device is described referring to FIGS. 1 to 3. FIG. 1 is a schematic top view of the overall configuration of a retinal projection image display device 100. FIG. 2 is a schematic top view of an optical scanner 2 included in the retinal projection image display device 100 of FIG. 1. FIG. 3 is a schematic top view of a movable mirror 41 included in a variable optical system 4 of the retinal projection image display device 100 in FIG. 1.

The retinal projection image display device 100 illustrated in FIG. 1 is a wearable device, and is a retinal projection head mounted display (HMD) that directly projects images onto the retina of an observer through optical scanning using Maxwellian view. Maxwellian view is a theory that describes how light is projected onto the retina to create a clear image. According to Maxwellian view, a spatial light modulator (“SLM”) emits parallel beams of light that converge at the pupil's center and project onto the retina. Each SLM pixel stimulates a unique point on the retina. In FIG. 1, the retinal projection image display device 100 projects an image onto the eyeball 50 on the right side of an observer U. However, the retinal projection image display device 100 is not limited to projecting an image onto the eyeball 50 on the right side of the observer U. The retinal projection image display device 100 can also project an image onto the eyeball on the left side, or onto both eyeballs simultaneously.

As illustrated in FIG. 1, the retinal projection image display device 100 includes a first light source 1, an optical scanner 2, and an eyepiece optical system 3. The optical scanner 2 forms an image by scanning light L1 from the first light source 1. The eyepiece optical system 3 guides the exit pupil light from the optical scanner 2 toward the eyeball 50 of the observer U. The term “exit pupil” is a well understood term in optics and is a virtual aperture in an optical system. Only rays which pass through this virtual aperture can exit the system. The exit pupil is the image of the aperture stop in the optics that follow it. An observer's eye can see light only if it passes through the exit pupil. The retinal projection image display device 100 further includes a variable optical system 4 that changes the incident position of the light emitted from the first light source 1 onto the optical scanner 2. The variable optical system 4 is placed between the first light source 1 and the optical scanner 2. The retinal projection image display device 100 can move the exit pupil E.

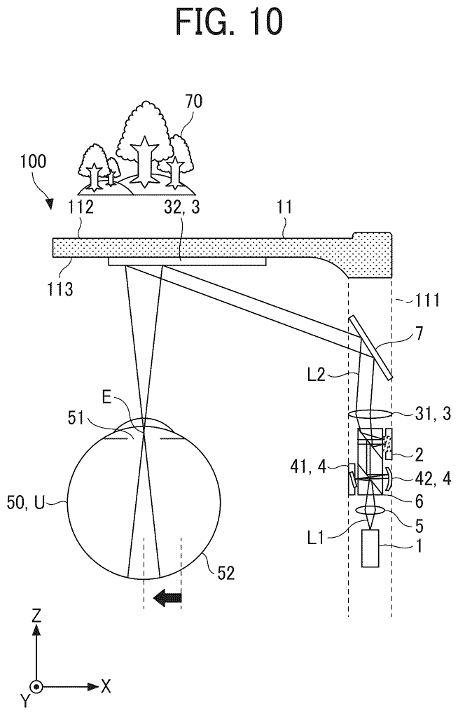

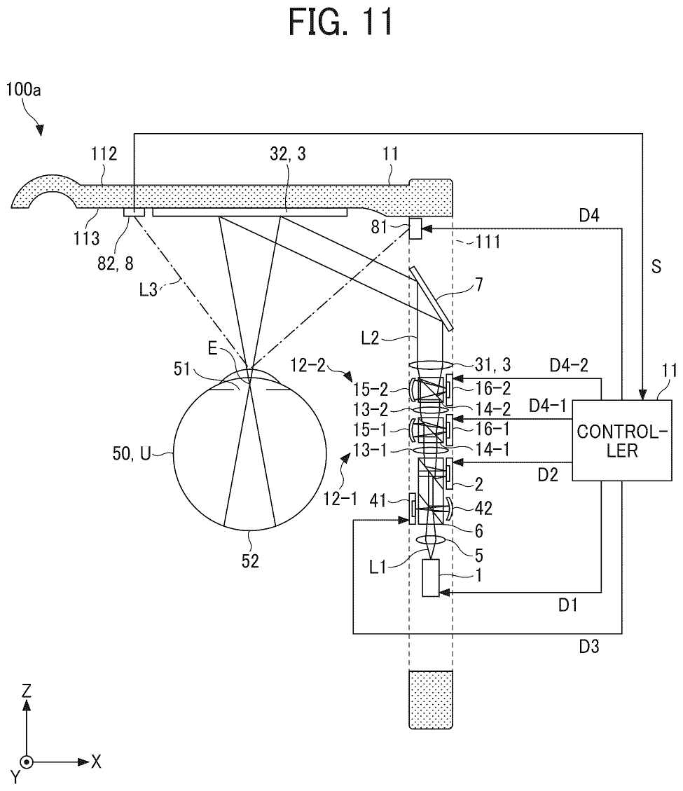

In FIG. 1, the retinal projection image display device 100 further includes a first lens 5, a prism 6 and a fixed mirror 7. The first lens 5 is placed between the first light source 1 and the variable optical system 4 and transmits the light L1 emitted from the first light source 1. The light L1 transmitted through the first lens 5 then enters the prism 6. The fixed mirror 7 reflects light L2 emerging from the prism 6 toward a holographic optical element 32 included in the eyepiece optical system 3. The retinal projection image display device 100 further includes a sensor 8 and a controller 9. The sensor 8 detects the position of a pupil 51 or a cornea of the observer U. The controller 9 controls the operations of the optical scanner 2 and the variable optical system 4 based on the position of the pupil 51 or the cornea of the observer U. The cornea of the observer U corresponds to the position of the region P of the corneal surface in FIG. 1. Further, the retinal projection image display device 100 includes a spectacle-shaped support 11 including a temple 111. In FIG. 1, the first light source 1, the optical scanner 2, the eyepiece optical system 3, the variable optical system 4, the first lens 5, the prism 6, the fixed mirror 7, the sensor 8, and the controller 9 are placed inside the temple 111. In FIG. 1 (and also FIGS. 10 and 11), the temple 111 extends in the up-down direction of the figure and is drawn with broken lines so that the components within the temple 111 can be clearly seen.

In FIG. 1, the light L1 emitted from the first light source 1 is transmitted through the first lens 5 and then enters the prism 6. The light L1 incident on the prism 6 is incident on the optical scanner 2 through the variable optical system 4. The light L2 scanned by the optical scanner 2 is transmitted through the second lens 31 included in the eyepiece optical system 3, and then reflected by the fixed mirror 7 toward the holographic optical element 32. The light L2 incident on the holographic optical element 32 is reflected while being converged by the holographic optical element 32 toward the eyeball 50 of the observer U. The light L2 reflected by the holographic optical element 32 passes through the exit pupil E and the pupil 51 of the eyeball 50 and reaches the retina 52. An image formed by the light L2 scanned by the optical scanner 2 is projected onto the retina 52. The viewer U can visually recognize the image projected onto the retina 52.

In recent years, technologies and products relating to virtual reality (VR) and augmented reality (AR) are getting attention. In particular, AR technology enhances real-world visual experiences and is expected to be applied in both consumer and industrial fields as a means of creating new added value by integrating digital information into real spaces. To promote widespread use, image display devices such as wearable head-mounted displays that can be used in action and work environments are being developed. To enable simultaneous viewing of the real world and images, transparent (see-through) types are mainstream. Wearable head-mounted displays, which display virtual images in front of the eyes through an eyepiece optical system such as a partial reflective mirror or image guide structure, have been introduced to the market. For wearable head-mounted displays used in real-world environments, optical quality that seamlessly integrates with daily life is a key factor, and style and design are also key elements. The wearable head-mounted displays that have been introduced to the market so far are clearly larger and less fashionable compared to traditional eyeglass frames, which has undoubtedly discouraged consumers. In the industry, the pursuit of stylishness remains a significant challenge. Wearable head-mounted displays are expected not only to feature a style that conveys a sense of beauty but also to deliver the added value of digital imagery with sufficient visual quality to the user.

In the above-described situation, a retinal projection image display device that uses a laser to project images directly onto the retina is gaining attention. In typical image display terminals that display virtual images, users focus on images drawn at a fixed depth. As a result, the depth plane where both real-world objects and the displayed images can be simultaneously in focus is limited, which hinders natural human behavior (tasks). On the other hand, in the retinal projection system using a laser, by utilizing Maxwellian view, the image is once focused on the pupil and projected onto the retina. This enables a focus-free characteristics that is not influenced by the observer's visual acuity or focal depth, allowing the image to be clearly seen regardless of where the observer focuses in the external environment. However, due to the characteristics of focusing the image on the pupil in the retinal projection method, the eye box (field of view) tends to become narrow. In the present disclosure, the eye box refers to the spatial area around the eyes in which the observer can move their gaze without losing sight of the image. In situations where the eye box is narrow, even slight changes in the observer's gaze can result in the image disappearing.

For example, in FIG. 1, the relative position of the eyeball 50 with respect to the spectacle-shaped support 11 varies depending on factors such as the shape of the observer U's face and the size of the eyeball 50. If the relative positions of the eyeballs 50 with respect to the spectacle-shaped support 11 differs for each observer U, the exit pupil E may shift away from the pupil 51, causing the light L2 to no longer pass through the pupil 51 and fail to reach the retina 52. Further, when the observer U changes their gaze direction, the position of the pupil 51 or cornea shifts. This causes the light L2 to no longer pass through the pupil 51 and fail to reach the retina 52. When the light L2 does not reach the retina 52, the observer U cannot visually recognize the image. When the observer U moves the eyeball 50 while viewing the image and the light L2 no longer passes through the pupil 51, the light L2 no longer reaches the retinas 52, and the image viewed by the observer U disappears.

A typical mechanism that moves an eyepiece optical system adjusts the eyepiece optical system according to the position of the pupil 51, aligning the exit pupil E so that the light entering the eyeball 50 passes through the pupil 51 and easily reaches the retina 52. However, an apparatus with such a typical mechanism may increase in size due to an increase in the size of the eyepiece optical system.

In the retinal projection image display device 100 according to the present embodiment, the variable optical system 4 is placed between the first light source 1 and the optical scanner 2, and changes the incident position of the light emitted from the first light source 1 onto the optical scanner 2. The eyepiece optical system 3 collimates the light L2 scanned by the optical scanner 2, converges the light L2 at different positions according to the incident position on the optical scanner 2, and forms exit pupils. With this configuration, a change in the incident position on the optical scanner 2 by the variable optical system 4 can be converted into a movement (shift) of the exit pupil E. Thus, the retinal projection image display device 100 can move the exit pupil E. In the present embodiment, the exit pupil E can be moved without a mechanism for moving the eyepiece optical system 3, and thus, the retinal projection image display device that can move the exit pupil E can be downsized. The present embodiment enables the movement of the exit pupil E and prevents the light L2 entering the eyeball 50 from being blocked by the pupil 51 when the eyeball 50 is tilted. Thus, the light L2 can easily reach the retina 52. Thus, the present embodiment can enlarge the eye box of the observer U.

In the retinal projection image display device 100 of FIG. 1, the variable optical system 4 converts the light L1 emitted from the first light source 1 into collimated light, and then causes the collimated light to enter the optical scanner 2. With this configuration, even when the distances between the variable optical system 4 and the optical scanner 2 change, the incident angles of the light L1 on the optical scanner 2 can remain the same. This is achieved without affecting the function of the variable optical system 4 to convert changes in the incident position on the optical scanner 2 into the movement of the exit pupil E.

In the retinal projection image display device 100 of FIG. 1, the variable optical system 4 includes a movable mirror 41 and a concave mirror 42 (or a light collimator) that converts light L1 from the movable mirror 41 into collimated light. In the variable optical system 4, the movable mirror 41 changes its tilt to change the reflection angle of the light L1, changing the incident position of the light L1 on the optical scanner 2. The movable mirror has a variable tilt. The variable optical system 4 reflects the light L1 from the movable mirror 41 by the concave mirror 42 and converts the light L1 into parallel light, converting the light SL from the movable mirror 41 into collimated light. The retinal projection image display device 100 can direct the collimated light L1 into the optical scanner 2 and change the incident position of the light L1 on the optical scanner 2 with a simple configuration that include the movable mirror 41 and the concave mirror 42.

In the retinal projection image display device 100 of FIG. 1, the optical scanner 2 and the variable optical system 4 are arranged in the temple 111 side by side in an extension direction in which the temple 111 extends. The extension direction in which the temple 111 extends is substantially orthogonal to the direction in which both eyes of the observer U, wearing the spectacle-shaped support 11, are aligned. In FIG. 1, the direction in which both eyes of the observer U wearing the spectacle-shaped support 11 are aligned corresponds to the X direction, and the direction substantially orthogonal to the direction in which the eyes are aligned corresponds to the Z direction. By arranging the optical scanner 2 and the variable optical system 4 side by side in the extension direction in which the temple 111 extends, the temple 111 can be made thinner, and the retinal projection image display device 100 can be made more compact than when the optical scanner 2 and the variable optical system 4 are arranged in a direction substantially orthogonal to the direction in which the temple 111 extends. The optical scanner 2 and the variable optical system 4 may be placed inside the temple 111 or on the surface of the temple 111.

In the retinal projection image display device 100 in FIG. 1, the eyepiece optical system 3 includes a holographic optical element 32 that is disposed to face the eyeball 50 of the observer U and reflects and converges the light L2 from the optical scanner 2 toward the eyeball 50. Since the holographic optical element 32 functions both to reflect the light L2 and to converge the light L2, the configuration of the eyepiece optical system 3 can be simplified, allowing the eyepiece optical system 3 to be downsized, compared to a system where separate elements are used for reflecting and converging light L2. By reducing the size of the eyepiece optical system 3, the retinal projection image display device 100 can be reduced in size.

In the retinal projection image display device 100 illustrated in FIG. 1, when the optical scanner 2 and the variable optical system 4 are not in operation, a reflecting mirror 92a (in FIG. 2, or a first optical scanning surface) of the optical scanner 2 and a reflecting surface 14 (in FIG. 3, or a second optical scanning surface) of the variable optical system 4 are positioned facing each other. In other words, the direction (e.g., −X-direction) in which the reflecting mirror 92a of the optical scanner 2 faces and the direction (e.g., +X-direction) in which the reflecting surface 14 of the variable optical system 4 faces are opposite to each other. Both the reflecting mirror 92a of the optical scanner 2 and the reflecting surface 14 of the variable optical system 4 correspond to optical scanning surfaces. With this configuration, the retinal projection image display device 100 can be made more compact.

The retinal projection image display device 100 illustrated in FIG. 1 includes the sensor 8 and the controller 9, and thus can control the operations of the optical scanner 2 and the variable optical system 4 so that the light L2 passes through the pupil 51 of the eyeball 50, even when the observer U changes the gaze direction or the position of the pupil 51 or cornea. This reduces the likelihood of the light L2 being blocked by the pupil 51 due to the position of the pupil 51 or the cornea, and increases the eyebox for the observer U.

In the retinal projection image display device 100 of FIG. 1, the sensor 8 includes a second light source 81 and a photosensor 82 that receives light L3 emitted from the second light source 81 and reflected by the eyeball 50 of the observer U and outputs information regarding the light-receiving position of the light received on the photosensor 82. The optical scanner 2 can scan the light L3 emitted from the second light sources 81 to be incident on the eyeball 50 of the observer U. The optical scanner 2 can scan the light L2, so even when the observer U significantly changes the gaze direction or the position of the pupils 51 or the cornea changes greatly, it is still possible to reduce the loss of the light L3 reflected from the eyeball 50 that would not reach the photosensor 82, making it easier to detect the position of the pupil 51 or cornea. The method described in US2020174564, which is incorporated herein by reference, is used to perform the process in which light from 81 reflects off the pupil 51 to the photosensor 82, indicating the position of the pupil.

The following describes the configuration of the retinal projection image display device 100 and its constituent elements.

### Spectacle-Shaped Support 11

The spectacle-shaped support 11 has the shape and appearance of a spectacle frame. In FIG. 1, the spectacle-shaped support 11 includes, in addition to the temple 111, a rim 112 connected to the temple 111, and an eyeglass lens 113 held by the rim 112. The eyeglass lens 113 includes a prescription spectacle lens.

The first light source 1 may be disposed outside the temple 111, and the light L1 emitted from the first light source 1 may be guided into the temple 111. The controller 9 may be placed inside the temple 111. In some examples, the controller 9 may be placed outside the temple 111, and the drive signal from the controller 9 may be supplied to the inside of the temple 111. In the spectacle-shaped support 11, the angle formed by the longitudinal direction of the temple 111 and the longitudinal direction of the rim 112 may not be orthogonal, and can be adjusted as appropriate.

### First Light Source 1

In FIG. 1, the first light source 1 is a semiconductor laser that emits a laser beam having a single wavelength or multiple wavelengths. More specifically, the first light source 1 include a red semiconductor laser, a green semiconductor laser, and a blue semiconductor laser. The first light source 1 emits the light L1, a time-modulated laser beam, in response to a drive signal D1 from the controller 9. The retinal projection image display device 100 can display a color image using the first light source 1 including a red semiconductor laser, a green semiconductor laser, and a blue semiconductor laser. However, the retinal projection image display device 100 can also display only a monochrome image, if desired. When the retinal projection image display device 100 displays a monochrome image, the first light source 1 may emit light of a single color.

The light intensity of the light L1 emitted from the first light source 1 is preset to an appropriate level that sufficiently considers the safety of the eyes of the observer U. However, the retinal projection image display device 100 may include an optical element for reducing the light intensity of the light L1 as needed. The retinal projection image display device 100 may include a light-receiving element, such as a photodiode, that receives the light L1 emitted from the first light source 1 and outputs a signal corresponding to its intensity. The retinal projection image display device 100 can control the light intensity of the light L1 based on the signal output from the light-receiving element, maintaining the safety of the observer U's eyes. The light intensity that maintains the safety of the observer U's eyes is determined by the International Electrotechnical Commission (IEC), an international standard for laser safety. The “light intensity” refers to levels below Class 1, as defined by IEC 60825-1. The first light source 1 is not limited to a semiconductor laser, and may be a solid-state laser or a gas laser.

The retinal projection image display device 100 can change the light intensity of the light L1 emitted from the first light source 1 by changing the current or voltage applied to the first light source 1. Thus, the retinal projection image display device 100 can adjust the brightness of the displayed image based on the brightness of the surrounding environment in which the retinal projection image display device 100 is used.

### Optical Scanner 2

As illustrated in FIG. 2, the optical scanner 2 includes a support substrate 91, a movable portion 92, a meandering beam portion 93, a meandering beam portion 94, and an electrode connection portion 95.

The optical scanner 2 is a micro electro mechanical systems (MEMS) mirror that oscillates (or rotates) around two axes substantially orthogonal to each other. The optical scanner 2 includes a reflecting mirror 92a in the movable portion 92 connected to the support substrate 91. The optical scanner 2 can scan the light L2, which is reflected by the reflecting mirror 92a after entering the reflecting mirror 92a as the light L1, by changing the angle of the reflecting mirror 92a through oscillating the movable portion 92. The optical scanner 2 can form an image using the scanned light L2.

In FIG. 1, the main scanning direction, in which pixels are continuously drawn over time to form a series of pixel groups, corresponds to the Z direction at the position of the optical scanner 2 and the X direction at the point of incidence (or incident position) on the eyeball 50. The sub-scanning direction, which is orthogonal to the main scanning direction and in which a series of pixel groups are arranged, corresponds to the Y direction for both the position of the optical scanner 2 and the incident position on the eyeball 50. Scanning speed in the main scanning direction is set higher than scanning speed in the sub-scanning direction.

In FIG. 2, the meandering beam portion 93 has multiple folded portions formed in a meandering manner. One end of the meandering beam portion 93 is connected to the support substrate 91 and the other end of the meandering beam portion 93 is connected to the movable portion 92. The meandering beam portion 93 includes a beam portion 93a including three beams and a beam portion 93b including three beams. The beams of the beam portion 93a and the beams of the beam portion 93b are alternately formed. Each beam included in the beam portion 93a and the beam portion 93b individually includes a piezoelectric member. The number of beams in each of the beam portions 93a and 93b is not limited to three, and may be determined as desired.

In FIG. 2, the meandering beam portion 94 has multiple folded portions formed in a meandering manner. One end of the meandering beam portion 94 is connected to the support substrate 91 and the other end of the meandering beam portion 94 is connected to the movable portion 92. The meandering beam portion 94 includes a beam portion 94a including three beams and a beam portion 94b including three beams. The beams of the beam portion 94a and the beams of the beam portion 94b are alternately formed. Each beam included in the beam portion 94a and the beam portion 94b individually includes a piezoelectric member. The number of beams in each of the beam portions 93a and 93b is not limited to three, and may be determined as desired.

The piezoelectric member included in the beam portions 93a, 93b, 94a, and 94b is formed as a piezoelectric layer in a part of a layer of each beam formed in, for example, a multilayer structure. In the following description, the piezoelectric members included in the beam portions 93a and 94a are collectively referred to as piezoelectric members 95a, and the piezoelectric members included in the beam portions 93b and 94b are collectively referred to as piezoelectric members 95b. When voltage signals having opposite phases are applied to the piezoelectric member 95a and the piezoelectric member 95b to warp the meandering beam portions 94, the adjacent beam portions are bent in different directions (i.e., bending). This bending accumulates, generating a driving force that oscillates the reflecting mirror 92a back and forth around A-axis, which is parallel to the β-direction.

In FIG. 2, the movable portion 92 is formed so as to be sandwiched between the meandering beam portions 93 and 94 in the β-direction. The movable portion 92 includes the reflecting mirror 92a, a torsion bar 92b, a piezoelectric member 92c, and a support 92d.

The reflecting mirror 92a includes, for example, a base member and a metal thin film provided by vapor deposition on the base member. The metal thin film includes, for example, aluminum (Al), gold (Au), or silver (Ag). One end of the torsion bar 92b is connected to the reflecting mirror 92a and extends along ±α-direction to support the reflecting mirror 92a to allow rotation.

In the piezoelectric member 92c, one end is connected to the torsion bar 92b whereas the other end is connected to the support 92d. When voltage is applied to the piezoelectric member 92c, the piezoelectric member 92c bends and deforms, causing torsion in the torsion bar 92b. The torsion of the torsion bar 92b acts as a driving force, causing the reflecting mirror 92a to oscillate around the B-axis, which is parallel to the α-direction.

The oscillation of the reflecting mirror 92a around the A-axis causes the light L1 incident on the reflecting mirror 92a to scan in the α-direction. The oscillation of the reflecting mirror 92a around the B-axis causes the light L1 incident on the reflecting mirror 92a to scan in the β-direction.

The support 92d is formed so as to surround the reflecting mirror 92a, the torsion bar 92b, and the piezoelectric member 92c. The support 92d is coupled to the piezoelectric member 92c and supports the piezoelectric member 92c. The support 92d indirectly supports the piezoelectric member 92c, the torsion bar 92b, and the reflecting mirror 92a, which are connected to the piezoelectric member 92c.

The support substrate 91 is formed so as to surround the movable portion 92, the meandering beam portion 93, and the meandering beam portion 94. The support substrate 91 is connected to the meandering beam portion 93 and the meandering beam portion 94 to support the meandering beam portion 93 and the meandering beam portion 94. The support substrate 91 also indirectly supports the movable portion 92 connected to the meandering beam portion 93 and the meandering beam portion 94.

The optical scanner 2 is an MEMS formed by, for example, a micromachining technique. For example, silicon or glass is used for micromachining. A movable micro-reflecting mirror can be formed with high precision on a substrate, integrated with a driving component such as a meandering beam portion, using micromachining technique. Specifically, a single silicon on insulator (SOI) substrate is formed by etching. A reflecting mirror, a meandering beam portion, a piezoelectric member, an electrode connection part are integrally formed on the SOI substrate, creating the MEMS mirror. The reflective mirror may be formed after or during the formation of the SOI substrate.

The SOI substrate is a substrate in which a silicon oxide layer is provided on a silicon support layer made of single crystal silicon (Si), and a silicon active layer made of single crystal silicon is further provided on the silicon oxide layer. The silicon active layer has a smaller thickness in the γ-direction than that along the α-direction or the β-direction. With such a configuration, any component made of the silicon active layer serves as an elastic member having elasticity. The SOI substrate is not limited to being planar, and may have, for example, a curvature. As long as the substrate can be integrally fabricated by etching and can partly add elasticity, a member used for forming the MEMS mirror is not limited to the SOI substrate.

The optical scanner 2 is not limited to a two-axis MEMS mirror and may apply a vector scan MEMS mirrors or two single-axis MEMS mirrors. An optical element capable of continuously deflecting light, such as a polygon mirror or a galvano mirror, may be used, or a combination thereof may be used. The use of the MEMS mirror is preferable because the retinal projection image display device 100 can be reduced in size and weight. A configuration using a single two-axis MEMS mirror is preferable as such a configuration allows the retinal projection image display device 100 to be smaller and lighter. The MEMS mirror can be driven using any of the following methods: electrostatic, piezoelectric, or electromagnetic.

### Eyepiece Optical System 3

The holographic optical element 32 in the eyepiece optical system 3 includes at least one holographic film. The hologram region serves as a volumetric hologram, reflecting the light L2, either directly or indirectly incident from the optical scanner 2, toward the observer U's eyeball 50 to form the exit pupil E. A material of the holographic film may be Bayfol® HX that is available from Bayer Material Science AG or a photopolymer film that is available for use in this technology. When the holographic optical element 32 reflects and focuses light having multiple wavelengths, the holographic optical element 32 may be formed of a single layer of a wavelength-multiplexed holographic film. Alternatively, the holographic optical element 32 may be formed by laminating multiple holographic film layers whose wavelength bands include multiple wavelengths to be reflected and collected. Alternatively, the holographic optical element 32 may be an angle-multiplexed hologram.

The optical element, which reflects light L2 directly or indirectly incident from the optical scanner 2, toward the eyeball 50 of the observer U, is not limited to the holographic optical element 32. Such an optical element may be a diffractive optical device using liquid crystal or surface relief, or a free-form surface mirror. However, the holographic optical element 32 can be made thin, providing advantage of clear external visibility.

The eyepiece optical system 3 may include the holographic optical element 32. The eyepiece optical system 3 may include other elements, such as a fixed mirror 7, in addition to the second lens 31 and the holographic optical element 32. The holographic optical element 32 is not limited to being placed on the surface of the eyeglass lens 113 and may also be integrated with the eyeglass lens 113.

### Variable Optical System 4

The movable mirror 41 illustrated in FIG. 3 is a vector scan MEMS mirror. The movable mirror 41 illustrated in FIG. 3 has the reflecting surface 14 on a movable portion 101 connected to a support substrate 102. The movable mirror 41 can selectively switch the light reflection direction by driving the movable portion 101 and changing the angle of the reflecting surface 14. The movable mirror 41 can rotate around the A-axis along a β-axis, and its angle can be controlled at any position within its movable range by a drive voltage signal. The movable mirror 41 can rotate around the B-axis along a α-axis, and its angle can be controlled at any position within its movable range by a drive voltage signal. In other words, the movable mirror 41 can reflect the light L1 incident from the first lens 5 to any position in an αβ plane within the movable range, and reflects the light L1 toward a concave mirror 42. The movable mirror 41 is placed between the first light source 1 and the optical scanner 2. The support substrate 102 of the movable mirror 41 is placed to be parallel to the longitudinal direction of the temple 111.

The movable mirror 41 illustrated in FIG. 3 includes a movable portion 101 and a support substrate 102. The movable portion 101 reflects incident light L1. The support substrate 102 is connected to the movable portion 101 and supports a first member 110, a second member 120, a third member 130, and a fourth member 140, which include piezoelectric drivers 113a, 113b, 113c, and 113d. Additionally, the movable mirror 41 illustrated in FIG. 3 includes a connecting portion 102a that connects the first member 110 to the movable portion 101, a connecting portion 102b that connects the second member 120 to the movable portion 101, a connecting portion 102c that connects the third member 130 to the movable portion 101, and a connecting portion 102d that connects the fourth member 140 to the movable portion 101. The movable mirror 41 also includes electrode connection parts or connectors or pads 150a to 150h, which electrically connect the piezoelectric drivers 113a, 113b, 113c, and 113d to the controller.

In FIG. 3, the movable mirror 41 includes, for example, one silicon-on-insulator (SOI) substrate formed using any appropriate processing method, such as etching. On this SOI substrate, the reflecting surface 14, the piezoelectric drivers 131a, 113b, 113c, and 113d, as well as the electrode connection parts 150a to 150h, are integrated, forming a unified structure of the above-described components. The above-described components may be formed after the SOI substrate is molded, or may be formed during the formation of the SOI substrate.

In FIG. 3, the SOI substrate includes a silicon oxide layer on a silicon support layer made of single crystal silicon (Si), with a silicon active layer also made of single-crystal silicon, on top of the silicon oxide layer. The silicon active layer has a smaller thickness in the γ-direction than that along the α-direction or the β-direction. With such a configuration, any component made of the silicon active layer serves as an elastic member or elastic having elasticity. The SOI substrate is not limited to being planar, and may have, for example, a curvature. As long as the substrate can be integrally fabricated by etching and can partly add elasticity, a member used for forming the MEMS mirror is not limited to the SOI substrate.

In FIG. 3, the reflecting surface 14 includes a thin metal film containing, for example, aluminum (Al), gold (Au), and silver (Ag). The movable portion 101 may include a rib for strengthening the movable portion 101, on the −γ-side surface of the movable-portion base 103. Such a rib includes, for example, the silicon support layer 124 and the silicon oxide layer 125, serving to prevent the distortion of the reflecting surface 14 due to the motion.

In FIG. 3, the shape or configuration of the first member 110, the second member 120, the third member 130, and the fourth member 140 may be, for example, a meander structure or a cantilever structure. Further, sensors may be installed in the first member 110, the second member 120, the third member 130, and the fourth member 140, separately from the piezoelectric drivers 113a, 113b, 113c, and 113d. The sensors include piezoelectric or strain-resistant displacement detection sensor that output signals according to the deformations of the members, or temperature sensors.

The details of the shape of the connecting portions 102a, 102b, 102c, and 102d connecting the first member 110, the second member 120, the third member 130, and the fourth member 140 with the movable portion 101 are not limited to those illustrated in FIG. 3. Further, the angle formed by the straight lines connecting the center of the movable portion 101 and the connecting portions 102a, 102b, 102c, and 102d is preferably substantially 90 degrees in plan view. However, no limitation is intended thereby. Further, each of the piezoelectric drivers 113a, 113b, 113c, and 113d may also have functions other than driving. For example, each of the piezoelectric drivers 113a, 113b, 113c, and 113d may have a function of detecting displacement, a function of a heater, or a function of electric wiring. The shape of the movable portion 101 is not limited to that illustrated in FIG. 3.

The driving method of the piezoelectric drivers 113a, 113b, 113c, and 113d illustrated in FIG. 3 uses a piezoelectric driving method. However, the driving method of piezoelectric drivers 113a, 113b, 113c, and 113d is not limited to piezoelectric driving and may include, for example, an electromagnetic method that deforms the support portion using an electromagnetic field, an electrostatic driving method that forms comb-tooth electrodes on the support portion, or a thermoelectric method that utilizes thermal expansion differences between various components. In some examples, coils or magnet array may be formed on the support substrate 102. Among these techniques, the piezoelectric driving is advantageous because the piezoelectric drivers 113a, 113b, 113c, and 113d can be effectively placed, and upsizing of the movable mirror 41 as a whole can be prevented. The electrostatic driving method uses comb-teeth electrodes at the periphery of the drivers and is likely to increase the overall size of the movable mirror 41. Further, the electromagnetic method faces challenges in arranging wires and magnets to apply magnetic fields to multiple drivers. The electromagnetic method may also increase the overall size of the movable mirror. The piezoelectric drivers 113a, 113b, 113c, and 113d illustrated in FIG. 3 are not limited to being placed only on one surface (+γ-side) of the silicon active layer 126, which is the elastic portion. The piezoelectric drivers 113a, 113b, 113c, and 113d may be placed on the opposite surface (e.g., −γ-side) or on both surfaces of the elastic portion.

In some embodiments, an insulating layer including the silicon oxide layer is disposed on at least any one of the +γ-side surfaces of the upper electrodes of the piezoelectric drivers 113a, 113b, 113c, and 113d and the +γ-side surfaces of the support substrate 102. In this case, electrode wiring is provided on the insulating layer, and the insulating layer is partially removed as an opening or is not placed at a connection spot where the upper electrode or the lower electrode and the electrode wiring are connected. Thus, the piezoelectric drivers 113a, 113b, 113c, and 113d as well as the electrode wiring can be designed with higher flexibility, and, furthermore, short circuits due to contact between electrodes can be prevented.

The silicon oxide film in the movable mirror 41 of FIG. 3 also functions as an anti-reflection material. The piezoelectric portions of the piezoelectric drivers 113a, 113b, 113c, and 113d, when a positive or negative voltage in the polarization direction is applied thereto, are deformed (for example, expanded or contracted) in proportion to the potential of the applied voltage, and exhibit inverse piezoelectric effect. The piezoelectric drivers 113a, 113b, 113c, and 113d bend and deform to exert a driving force around the rotation axis of the movable portion 101 through the connection portions 102a, 102b, 102c, and 102d. This action moves the movable portion 101 around the A-axis parallel to the β-axis or the B-axis parallel to the α-axis.

The first member 110 is positioned at substantially 45 degrees with respect to each of the A-axis and the B-axis. In other words, the rotation of the movable portion 101, caused by the oscillation of the first member 110, second member 120, third member 130, and fourth member 140, has vector components along both the A-axis and B-axis. For example, when voltage is applied to the piezoelectric drivers 113a and 113b but not to the piezoelectric drivers 113c and 113d, the movable portion 101 tilts around the rotational axis of the B-axis. Similarly, when voltage is applied to the piezoelectric drivers 113a and 113d but not to the piezoelectric drivers 113c and 113d, the movable portion 101 tilts around the rotational axis of the A-axis. In particular, when using a driving frequency that does not match the structure's natural resonant frequency, the rotational direction of the movable portion 101 can be freely controlled by the driving signal. In other words, by controlling the independent or combined operation of each piezoelectric driver 113a, 113b, 113c, and 113d, the movable portion 101 can oscillate in the desired direction, enabling vector scanning.

The reference voltage of the piezoelectric drivers 113a, 113b, 113c, and 113d may be 0 V or any voltage within the maximum amplitude that is produced by an applicable voltage generator. The piezoelectric drivers 113a, 113b, 113c, and 113d may differ from each other. In some embodiments, the signal waveform of the applied voltage is a periodic waveform such as a sine wave, a rectangular wave, or a sawtooth wave. In other examples, the signal waveform is a more complicated periodic waveform. The piezoelectric drivers 113a, 113b, 113c, and 113d may be DC-driven.

Turning back to FIG. 1, the movable mirror 41 is not limited to a vector scan MEMS mirror, and may be two single-axis MEMS mirrors. The use of the vector scan MEMS mirror is preferred, as the vector scan MEMS mirror reduces the size and weight of the retinal projection image display device 100. In some examples, the movable mirror 41 may be one single-axis MEMS mirror. In this case, the movable mirror 41 can reflect the light L1, entering from the first lens 5 in FIG. 1, in either the Y-axis or Z-axis direction. This limits the eyebox expansion to a single dimension.

The concave mirror 42 of FIG. 1 converts the incident light L1 into collimated light. The concave mirror 42 may be configured to include a resin material or a glass material. A metal film may be disposed on the surface of a resin material or a glass material. The concave surface of the concave mirror 42 may be a spherical surface, and may include an aspherical surface in at least a part thereof.

### First Lens 5

The first lens 5 illustrated in FIG. 1 can be made from glass, resin, or similar materials that have a transmittance of 60% or higher for the peak wavelength of the light L1 emitted from the first light source 1. The first lens 5 is not limited to a single lens and may also include two or more lenses.

### Prism 6

The prism 6 illustrated in FIG. 1 guides the light L1, entering from the first lens 5, to both the optical scanner 2 and the variable optical system 4. However, the configuration for guiding the light L1 from the first lens 5 to both the optical scanner 2 and the variable optical system 4 is not limited to using the prism 6 and can be modified as needed. The prism 6 can be made from glass material that have a transmittance of 60% or higher for the peak wavelength of the light L1 emitted from the first light source 1.

### Sensor 8

The second light source 81 in the sensor 8 of FIG. 1 is a semiconductor laser that directs light L3 toward the pupil 51 of the eyeball 50. This light source can be a vertical cavity surface-emitting laser (VCSEL) or a laser diode array (LDA) with multiple light-emitting elements, or a semiconductor laser emitting a single or multiple wavelengths of laser light.

The light L3 emitted from the second light sources 81 preferably has wavelengths of near-infrared light, which is non-visible light, to prevent the visual recognition of the observer U whose gaze direction is detected, from being hampered. However, the light L3 is not limited to non-visible light, and may also be visible light. The second light source 81 is positioned to face the optical scanner 2 through the prism 6 so that the emitted light L3 enters the optical scanner 2.

The photosensor 82 is at least one photodiode that receives the light L3 emitted from the second light source 81, which passes through elements such as the holographic optical element 32, enters the eyeball 50, and is then reflected by the eyeball 50. In FIG. 1, the corneal surface of the observer U's eyeball 50, which is a transparent body containing moisture, typically has a reflectance of about 2 to 4%. The light L3 incident on the observer U's eyeball 50 is reflected at the region P of the corneal surface of the eyeball 50 and then enters the photosensor 82. The photosensor 82 is not limited to a photodiode and may also be a position-sensitive detector (PSD), an imaging device such as a charge-coupled device (CCD), a complementary metal oxide semiconductor (CMOS), or any other type of photosensor that accomplishes the desired sensing.

The sensor 8 is not limited to including only the second light source 81 and the photosensor 82 and may also detect the position of the observer U's pupil 51 or cornea using a photosensor positioned inside or outside the peripheral area of the eyeglass lens 113.

### Controller 9

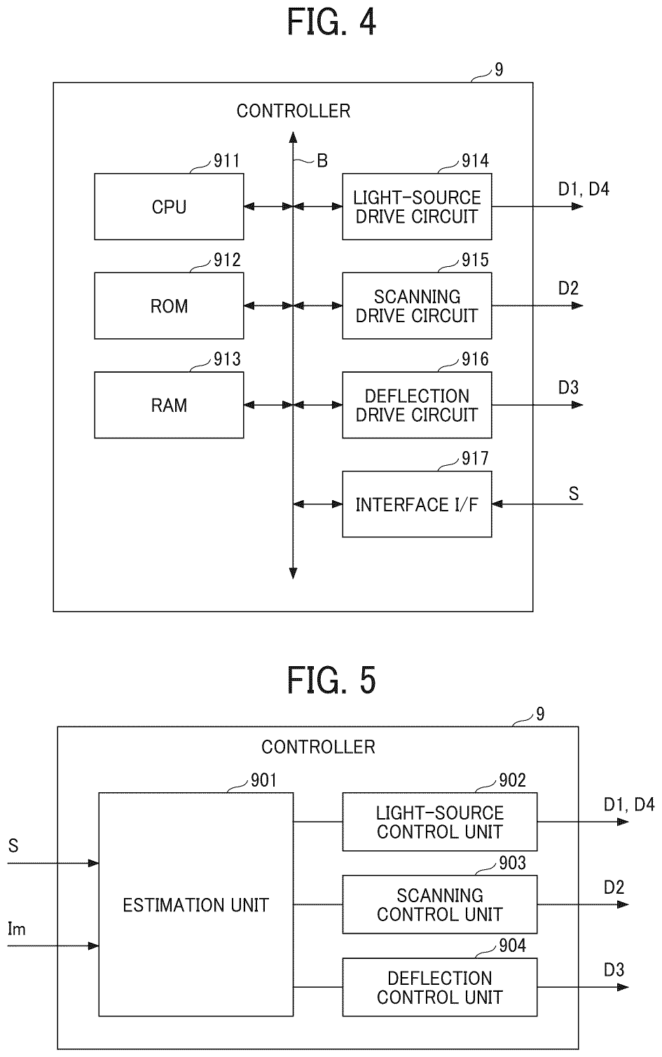

The controller 9 inputs the image data that forms the basis of the generated image and, based on this data, controls the emission of light L1 from the first light source 1. The controller 9 also controls the emission of light L3 from the second light source 81. The controller 9 also controls the scanning of light L2 by the optical scanner 2. The controller 9 does so by adjusting the operation of the optical scanner 2 based on the emission timing of each light-emitting element in the second light source 81 and the information S regarding the light-receiving position of the light received on the photosensor 82, from the photosensor 82, which detects the position of the observer U's pupil 51 or cornea. The controller 9 also controls the position of light L1, which is directed to the optical scanner 2 either directly or indirectly from the movable mirror 41, by adjusting the operation of the movable mirror 41. The configuration of the controller 9 will be described in detail separately, with reference to FIGS. 4 and 5.

### Behavior of Light in Retinal Projection Image Display Device 100

The behavior of light in the retinal projection image display device 100 will be described in more detail with reference to FIG. 1. In FIG. 1, the divergent light L1 emitted from the first light source 1 is focused by the first lens 5 to form a focal point on the mirror surface of the movable mirror 41. The light L1, focused by the first lens 5, is reflected by the reflecting surface of the prism 6 and directed onto the movable mirror 41. The movable mirror 41 reflects the incoming light L1 to any position within the YZ plane within its movable range. The light L1 reflected by the movable mirror 41 is directed toward the concave mirror 42. The collimated light reflected by the concave mirror 42 is reflected again by the reflecting surface within the prism 6 and then directed into the optical scanner 2.

The optical scanner 2 scans the incoming light L1 in two axes, forming an image with the scanned light L2. The light L2 is reflected by the reflecting surface within the prism 6, directed into the second lens 31, then reflected by the fixed mirror 7, and finally directed into the holographic optical element 32. The holographic optical element 32 reflects the incoming light L2 toward the observer U's eyeball 50, forming an exit pupil E. When the position of the observer U's pupil 51 aligns with the exit pupil E, light L2 passes through the pupil 51 and enters the interior of the eyeball 50. The light L2 entering the interior of the eyeball 50 is initially focused near the center of the pupil 51 due to the light-focusing function of the holographic optical element 32. The light L2 then forms an image on the retina 52 at the back of the eyeball 50.

The above viewing state is commonly referred to as Maxwellian view. Since light passing near the center of the pupil 51 reaches the retina 52 regardless of the focus adjustment of the crystalline lens, it is generally understood that the observer U can view the projected image sharply and in focus, regardless of where their eye is focused in real space. The crystalline lens is a part of the human eye. In reality, since the laser beam incident on the eyeball 50 has a small, finite diameter, a slight influence from the lens function of the crystalline lens remains. Thus, it is desirable for the optical scanner 2 and the holographic optical element 32 to be designed so that the diameter of light L2 upon entering the eyeball 50 is between 300 μm and 800 μm, with a positive, finite beam divergence angle, meaning the light should be divergent. With this design, the image formed by the light L2 scanned by the optical scanner 2 reaches the retina 52 via the holographic optical element 32, unaffected by the focus adjustment of the crystalline lens. This enables the observer U to clearly see the image on the retina 52 at all times, regardless of where their eye is focused in real space. In other words, the image formed by the light L2 scanned by the optical scanner 2 is visually recognized by the observer U in a focus-free state.

When the reflecting surface in the prism 6 is intended to function as a polarization beam-splitting surface, or as a reflecting surface with a dielectric multilayer film, a quarter-wave plate may be placed at an appropriate location. The polarization beam-splitting surface and the quarter-wave plate enhance the light utilization efficiency of the retinal projection image display device 100.

In FIG. 1, the light L3 emitted from the second light sources 81 is incident on the optical scanner 2. The light L3 incident on and reflected by the optical scanner 2 is subsequently reflected by the reflecting surface in the prism 6, passes through the second lens 31, is reflected by the fixed mirror 7, and then reaches the holographic optical element 32. The light L3 is directed to the eyeball 50 along the same optical path as the light L2.

The light L3 is preferably reflected by the optical scanner 2 at a scanning timing when the optical scanner 2 is deflected to an angle greater than its deflection angle. With this setting, the light L3 passes through regions closer to the outer edges of the second lens 31, the fixed mirror 7, and the holographic optical element 32 than the light L2 does. The fixed mirror 7 and the holographic optical element 32 can be custom-designed to have optical functions in the region where light L3 is incident that differ from those in the region where light L2 is incident. By sharing the component through which the light L2 and the light L3 pass, the retinal projection image display device 100 can be reduced in size and weight.

### Configuration of Controller 9

### Hardware Configuration

FIG. 4 is a block diagram illustrating a hardware configuration of the controller 9. The controller 9 illustrated in FIG. 4 includes a central processing unit (CPU) 911, a read only memory (ROM) 912, a random access memory (RAM) 913, a light-source driving circuit 914, a scanning driving circuit 915, and a deflection driving circuit 916.

These are electrically connected to each other via a system bus B.

The CPU 911 is an arithmetic device that reads programs and data from a storage device, such as a ROM 912, into the RAM 913, executes processing, and implements the overall control and functions of the controller 9.

The ROM 912 is a read-only nonvolatile storage device that can store a computer program or data even when the power is switched off. The ROM 912 stores the processing programs and data that the CPU 911 executes to control the various functions of the retinal projection image display device 100. The RAM 913 is a volatile storage device that temporarily stores programs and data.

The light-source drive circuit 914 is an electric circuit that is electrically connected to the first light source 1 and the second light source 81, applies a current or a voltage to each of the first light source 1 and the second light source 81, and drives each of the first light source 1 and the second light source 81. The first light source 1 emits light L1, turning ON or OFF and adjusting the light intensity of the emitted light L1 in response to a drive signal D1 output from the light-source drive circuit 914. The first light source 1 emits light L3, turning ON or OFF and adjusting the light intensity of the emitted light L3 in response to a drive signal D4 output from the light-source drive circuit 914.

The scanning drive circuit 915 is an electric circuit that is electrically connected to the optical scanner 2 and drives the optical scanner 2 by applying a voltage D2 to the optical scanner 2. The optical scanner 2 changes the angle of the reflecting mirror 92a included in the movable portion 92 in response to a drive signal D2 output from the scanning drive circuit 915

The scanning drive circuit 916 is electrically connected to the movable mirror 41 and drives the movable mirror 41 by applying a voltage to the movable mirror 41. The movable mirror 41 adjusts the tilt angle of the reflecting surface 14 included in the movable portion 101 in response to a drive signal D3 output from the deflection drive circuit 916.

An external I/F 917 is an interface with an external device or a network. The external device may be, for example, a host device such as a personal computer (PC); or a storage device, such as a universal serial bus (USB) memory, a secure digital (SD) card, a compact disk (CD), a digital versatile disk (DVD), a hard disk drive (HDD), or a solid-state drive (SSD). The network may be, for example, a controller area network (CAN) of a vehicle, a local area network (LAN), or the Internet. The external I/F 917 can have any configuration that can achieve connection to an external device or communication with an external device. The external I/F 917 may be provided for each external device.

The CPU 911 of controller 9 obtains the image data from an external device or a network via the external I/F 917. It is sufficient if the CPU 911 is configured to acquire image information. The image data may be stored in the ROM 912 within the controller 9, or a storage device such as a secure digital (SD) card may be additionally installed in the controller 9 to store the image data. The controller 9 can implement the functional configuration described below using instructions from the CPU 911 and the hardware configuration illustrated in FIG. 4.

### Functional Configuration

FIG. 5 is a block diagram illustrating the functional configuration of the controller 9. The controller 9 illustrated in FIG. 5 includes an estimation unit 901, a light-source control unit 902, a scanning control unit 903, and a deflection control unit 904. The controller 9 may also function to correct distortion when the image visually recognized by the observer U appears distorted.

The functions of the estimation unit 901, the light-source control unit 902, the scanning control unit 903, and the deflection control unit 904 can be implemented by the external I/F 917 and by the CPU 911 executing processes specified by programs stored in the ROM 912. Some functions of the light-source control unit 902 may be implemented by the light-source drive circuit 914. Some functions of the scanning control unit 903 may be implemented by the light-source drive circuit 915. Some functions of the deflection control unit 904 may be implemented by the deflection driving circuit 916. The functions of the estimation unit 901, the light-source control unit 902, the scanning control unit 903, and the deflection control unit 904 may be included in configurations outside the controller 9. For example, an external device, such as a microcontroller or PC that can communicate with the controller 9, may have at least some of the functions of the estimation unit 901, the light-source control unit 902, the scanning control unit 903, and the deflection control unit 904.

The functions provided by the controller 9 can also be implemented by one or more processing circuits or processing circuitry. The processing circuits or circuitry includes an application specific integrated circuit (ASIC), a field-programmable gate array (FPGA), a digital signal processor (DSP), or an electric circuit that can execute the functions described above. In some examples, some of the functions of the controller 9 are implemented by an external device such as an external PC or an external server that is communicably connected to the controller 9. Further, some of the functions of the controller 9 may be implemented through distributed processing between the controller 9 and an external device.

The estimation unit 901 estimates the position of the observer U's pupil 51 or cornea based on the emission timing of each light-emitting element of the second light source 81 and the information S regarding the light-receiving position output from the photosensor 82. The estimation unit 901 acquires image data Im obtained from an external device and, based on information regarding the position of the pupil 51 or cornea estimated by the estimation unit 901, converts the image data Im into control signals, which are then output to the light-source control unit 902, the scanning control unit 903, and the deflection control unit 904.

The light-source control unit 902 outputs the drive signal D1 to the first light source 1 and the drive signal D4 to the second light source 81 based on the control signal input from the estimation unit 901, and drives the first light source 1 and the second light sources 81. The scanning control unit 903 outputs the drive signal D2 to the optical scanner 2 based on the control signal input from the estimation unit 901, and drives the optical scanner 2. The deflection control unit 904 outputs the drive signal D3 to the movable mirror 41 based on the control signal input from the estimation unit 901, and drives the movable mirror 41.

### Moving Operation of Exit Pupil E in Retinal Projection Image Display Device 100

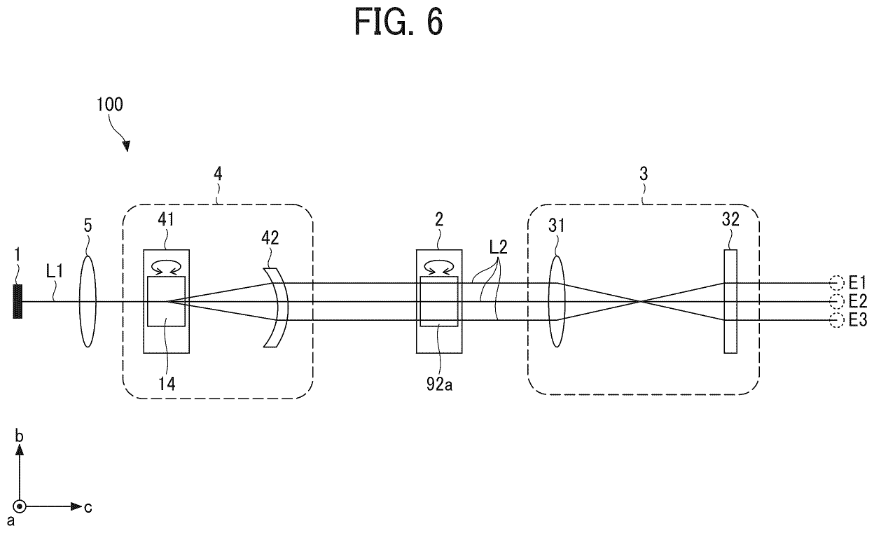

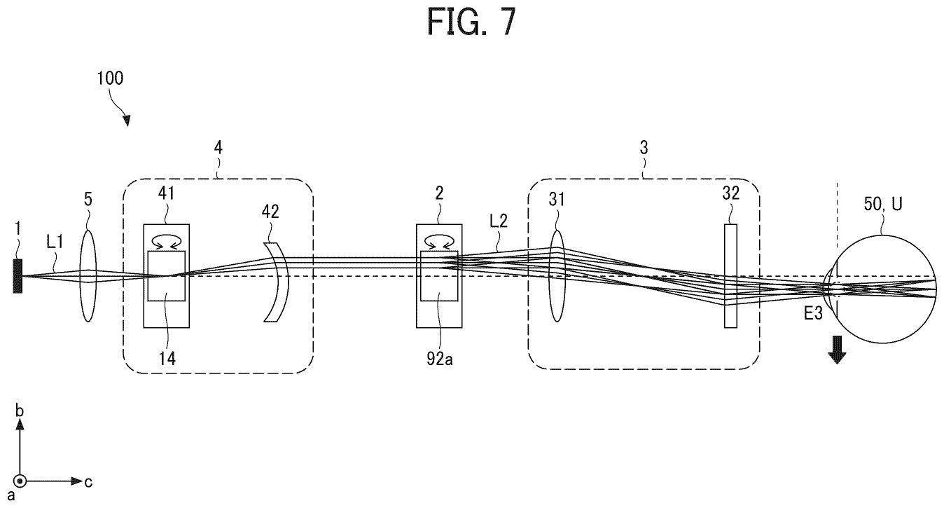

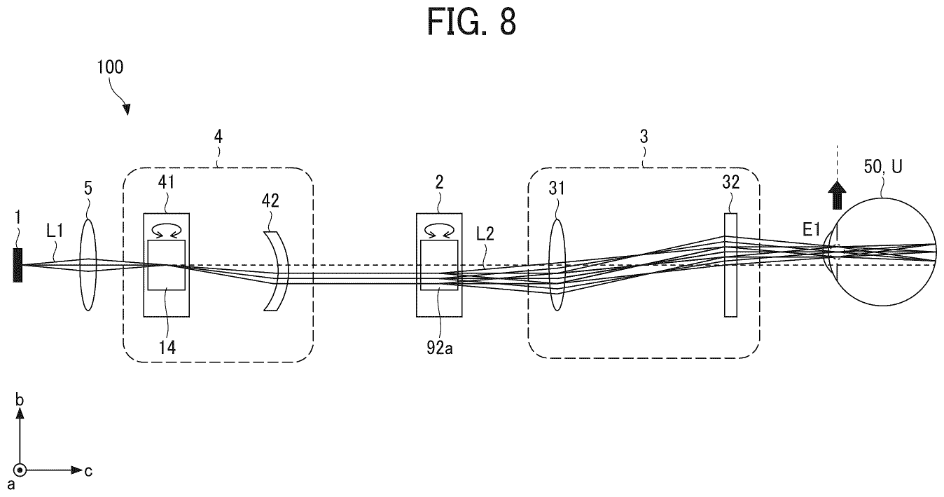

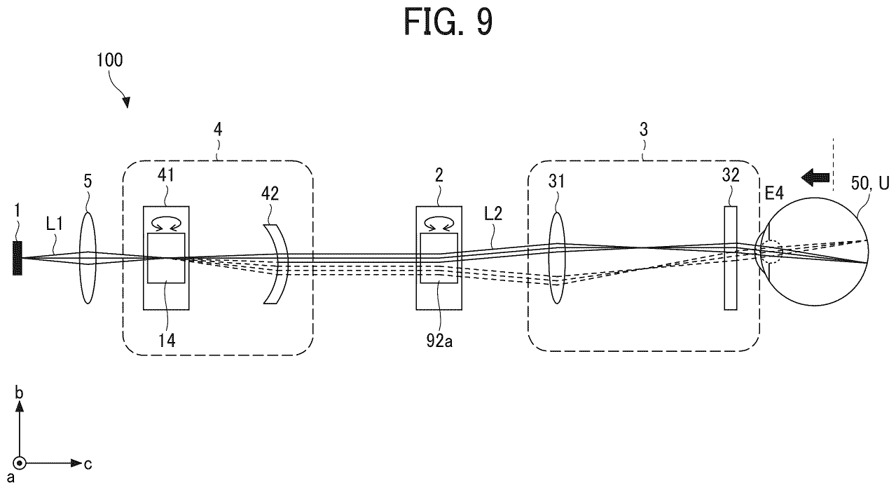

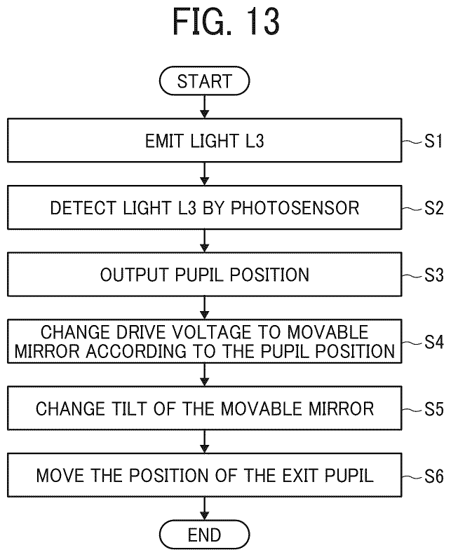

The movement operation of the exit pupil E by the retinal projection image display device 100 is described with reference to FIGS. 6 to 9. FIG. 6 is a schematic diagram illustrating an overview of the movement operation of the exit pupil E in the retinal projection image display device 100. FIG. 7 is a schematic diagram illustrating an overview of the movement operation of the exit pupil E in the retinal projection image display device 100. FIG. 8 is a schematic diagram illustrating an overview of the movement operation of the exit pupil E in the retinal projection image display device 100. FIG. 9 is a schematic diagram illustrating an overview of the movement operation of the exit pupil E in the retinal projection image display device 100. FIG. 13 is a flowchart of a process of moving an exit pupil E. In step S1, the light source control unit 902, also referred to as the light source drive circuit, causes the first light source 1 to emit light L3. In step S2, the light L3 is detected by the photosensor 82 is used to generate a detection signal. The estimation unit 901 estimates in step S3 the position of the pupil using the detection signal generated in step S2 (or the information S from the photosensor 82). The process of estimating or calculating the position of the pupil using the detection signal is described in US2020174564, which is incorporated by reference. Based on the detection signals of the periodically emitted light L3 received by the photosensor 82, the position of the pupil is continuously output in step S3. When the position of the pupil changes, in step S4, the deflection control unit 904 adjusts the drive voltage output from the deflection drive circuit 916 to the movable mirror 41 based on the position of the pupil, thus adjusting or changing the tilt of the movable mirror 41. For example, in the case of vector scanning MEMS, the tilt angle of the mirror can be uniquely determined by the method of applying the driving voltage. By changing the driving voltage according to the position of the pupil, the tilt of the movable mirror 41 is changed in step S5, which moves the exit pupil position to the desired location in step S6.

FIGS. 6 to 9 illustrate a simplified configuration for moving the exit pupil E in the retinal projection image display device 100 in FIG. 1, with the principal rays of the light L1 and the light L2 passing through the retinal projection image display device 100 represented as straight lines.

In FIG. 6, the light L1 emitted from the first light source 1 is converged by the first lens 5 to be focused on the reflecting surface 14 of the movable mirror 41. In FIG. 6, the movable mirror 41 can control the reflection direction of the light L1 along the b-axis. The light L1 reflected by the movable mirror 41 is converted into collimated light by the concave mirror 42. As a result, at all tilt angles within the tilt angle control range of the reflecting surface 14 of the movable mirror 41, the light L1 that is directly or indirectly incident on the optical scanner 2 from the movable mirror 41 becomes collimated light.

The optical scanner 2 is designed so that the light from the movable mirror 41 stays within the effective diameter of the reflecting mirror 92a of the optical scanner 2 when forming an image by scanning the light L1 from the movable mirror 41. With this configuration which allows the light L1 to strike within the effective diameter of the reflecting mirror 92a of the optical scanner 2, the tilt angle control range of the reflecting surface 14 of the movable mirror 41 is limited to the effective diameter of the reflecting mirror 92a of the optical scanner 2. However, within this constraint, the tilt angle can still be freely controlled. The light L2 incident on the eyepiece optical system 3 from the optical scanner 2 is collimated light.

As described above, the eyepiece optical system 3 collimates the light L2 scanned by the optical scanner 2, converges the light L2 at different positions according to the incident position on the optical scanner 2, and forms exit pupils. The holographic optical element 32 focuses the light L2 that is incident directly or indirectly from the optical scanner 2 to form the exit pupils E. In the retinal projection image display device 100, the passage position of the light L2 on the image side of the eyepiece optical system 3 moves in the b-direction in accordance with the tilt angle of the reflecting surface 14 of the movable mirror 41. This allows the exit pupil E to be moved to position E1 or position E3 by tilting the reflecting surface 14 of the movable mirror 41 around the a-axis as the rotation axis when forming the exit pupil E at the typical normal position E2.

The retinal projection image display device 100 can control the tilt angle of the reflecting surface 14 in two dimensions using the movable mirror 41, which is a vector scan MEMS mirror. The retinal projection image display device 100 can also move the exit pupil E in the a-direction by tilting the reflecting surface 14 of the movable mirror 41 around the b-axis as the rotation axis. The size of the eyebox in the retinal projection image display device 100 is determined by the effective diameter of the reflecting mirror 92a of the optical scanner 2 and the lateral magnification of the eyepiece optical system 3. The lateral magnification of the eyepiece optical system 3 is determined by the ratio of the focal lengths of the second lens 31 and the holographic optical element 32. For example, when the effective diameter of the reflecting mirror 92a of the optical scanner 2 is 2 mm and the lateral magnification is 2×, the size of the eyebox will be 4 mm.

In the retinal projection image display device 100, the exit pupils E can be moved in the c-direction by combining the tilt angle control of the reflecting surface 14 of the movable mirror 41 and the image formation control for generating the light L2 in a time-division manner. In other words, the retinal projection image display device 100 allows the exit pupil E to be moved in three-dimensional directions.

FIG. 7 illustrates the exit pupil E shifted in the −b-direction from the default position E2. FIG. 8 illustrates the exit pupil E shifted in the +b-direction from the default position E2.

In the retinal projection image display device 100, the sensor 8 first identifies the position of the center of the pupil 51 when the observer U is viewing straight ahead. The tilt angle of the reflecting surface 14 of the movable mirror 41 is determined so that the exit pupil E is formed at the identified position of the pupil 51 of the observer U. In FIG. 7, the position of the eyeball 50 of the observer U is shifted in the −b-direction from the default position E2. In FIG. 7, the light L1 emitted from the first light source 1 is converged by the first lens 5 to be focused on the reflecting surface 14 of the movable mirror 41. The reflecting surface 14 is tilted with the a-axis as the rotation axis, and the reflection direction is adjusted in the +b-direction. The light L1, focused and reflected by the reflecting surface 14, is collimated by the concave mirror 42 and then enters the optical scanner 2. At this time, the incident position of the light L1 on the reflecting mirror 92a of the optical scanner 2 is shifted in the +b-direction from the default position E2. Here, the incident position on the optical scanner 2 by the variable optical system 4 corresponds to the position of light L1 incident on the reflecting mirror 92a.

The light L1 incident on the optical scanner 2 is scanned by the optical scanner 2 to form an image. The scanned light L2 enters the eyepiece optical system 3, forms an intermediate focal point through the second lens 31, and is then reconverted into collimated light by the holographic optical element 32, forming the exit pupil E at position E3, as illustrated in FIG. 7. At this time, the exit pupil E located at the position E3 is aligned or overlapping with the pupil 51 of the observer U when the observer U is viewing straight ahead. Thus, the light L2 directed to the pupil 51 can pass through the pupil 51.

In FIG. 8, the position of the eyeball 50 of the observer U is shifted in the +b-direction from the default position E2. In FIG. 8, the light L1 emitted from the first light source 1 is converged by the first lens 5 to be focused on the reflecting surface 14 of the movable mirror 41. The reflecting surface 14 is tilted with the a-axis as the rotation axis, and the reflection direction is adjusted in the −b-direction. The light L1, focused and reflected by the reflecting surface 14, is converted into collimated light by the concave mirror 42, and then enters the optical scanner 2. At this time, the incident position of the light L1 on the reflecting mirror 92a of the optical scanner 2 is shifted in the −b-direction from the default position E2. The light L1 incident on the optical scanner 2 is scanned by the optical scanner 2 to form an image. The light L2 scanned by the optical scanner 2 enters the eyepiece optical system 3, forms an intermediate focal point through the second lens 31, and is then reconverted into collimated light by the holographic optical element 32, forming the exit pupil E at position E1. At this time, the exit pupil E is aligned or overlapping with the pupil 51 of the observer U when the observer U is viewing straight ahead. Thus, the light L2 directed to the pupil 51 can pass through the pupil 51.

As described above, in the retinal projection image display device 100, the exit pupil E can be moved by controlling the tilt angle of the reflecting surface 14 of the movable mirror 41. The distance between the pupils of both eyes typically varies from observer to observer. In the retinal projection image display device 100, the exit pupil E can be formed at the position where the light L2 passes through the pupil 51, regardless of the position of the center of the pupil 51 when the observer U is viewing straight ahead. Thus, the observer U can view an image over a predetermined finite angle of view.

The angle of view visible through the exit pupil W formed when viewing straight ahead is finite. When the observer U tilts their eyeball 50 beyond this finite angle of view and shifts their gaze, the image disappears as the light L2 is blocked by the pupil 51 of the observer U. To avoid such a situation, the sensor 8 constantly monitors the position of the pupil 51 of the observer U in the retinal projection image display device 100. When the observer U shifts the gaze beyond the finite angle of view visible through the exit pupil E formed when viewing straight ahead, the tilt angle of the reflecting surface 14 of the movable mirror 41 is controlled to adjust the position of the exit pupil E, aligning the exit pupil E with the pupil 51 of the observer U. The pupil 51 and the exit pupils E are aligned, and thus the light L2 can form an image on the retina 52 through the pupils 51. Thus, the retinal projection image display device 100 can enlarge the eyebox by moving the exit pupil E in accordance with the position of the pupil 51 of the observer U.

In the retinal projection image display device 100, the eyepiece optical system 3 collimates the light L2 scanned by the optical scanner 2, converges the light L2 at different positions according to the incident position on the optical scanner 2, and forms exit pupils. This configuration allows the state of the light L2 reaching the eyeball 50 to remain unchanged, regardless of the movement of exit pupil E, by using the movable mirror 41. This achieves uniform image quality and a consistent angle of view size across any viewing angle.

In the retinal projection image display device 100, the movable mirror 41 is a vector scan MEMS mirror. The movable mirror 41 as a vector scan MEMS mirror can control the tilt angle of the reflecting surface 14 in a two dimensions. The retinal projection image display device 100 can move the exit pupil E not only in the b-direction but also in the a-direction. In other words, in the retinal projection image display device 100, the exit pupil E can be moved in two dimensions to enlarge or shift the eye box, by merely controlling the tilt angle of the reflecting surface 14 of the movable mirror 41.

FIG. 9 illustrates the exit pupil E shifted in the +c-direction from the default position E2. In FIG. 9, the reflecting surface 14 of the movable mirror 41 rotates around an a-axis as the rotation axis, and time-division control is used to switch between reflecting at the default position E2 and reflecting in the −b-direction. In FIG. 9, the light L1 reflected at the default position E2, indicated by the solid line, and the light L1 reflected in the −b-direction, indicated by the dashed line, are converted into parallel light by the concave mirror 42 and are incident on different positions of the optical scanner 2.

In FIG. 9, light L1 (solid line) reflected by the reflecting surface 14 of the movable mirror 41 is emitted at a prescribed scan angle to form the exit pupil E at the default position E2. Light L2 (dashed line), which is the light L1 reflected in the −b-direction by the reflecting surface 14 of the movable mirror 41 and entering a position shifted in the −b-direction from the default position E2, is emitted at the prescribed scanning angle. Due to the eyepiece optical system 3, light L2 converges with light L1 at a position shifted by −c-direction from the exit pupil E in FIG. 7, forming the exit pupil at the position E4. In the retinal projection image display device 100, the movable mirror 41 can tilt to any position within the tilt angle control range of the reflecting surface 14, enabling the generation of various light beams within a specified finite range in combination with the scanning range of the optical scanner 2. As such, by selecting an appropriate light beam from the countless available beams and combining it with time-division image formation control, the exit pupil E can be moved in the c-direction. This allows the observer U to visually recognize images regardless of when the observer U's eyeball 50 shifts in the c-direction from the default position E2. As described above, the retinal projection image display device 100 enables the three-dimensional movement of the exit pupil E, resulting in a larger or shifted eye box in the three-dimensional direction.

### Operation Example of Retinal Projection Image Display Device 100

FIG. 10 is a schematic diagram illustrating the operation of the retinal projection image display device 100.

In FIG. 10, the light L1 emitted from the first light source 1 is converged by the first lens 5 to be focused on the reflecting surface 14 of the movable mirror 41. The light L1, focused by the first lens 5, is reflected by the reflecting surface of the prism 6 and directed onto the movable mirror 41. The sensor 8 identifies the position of the center of the pupil 51 of the observer U when the observer U is viewing straight ahead. Then, the tilt angle of the reflecting surface 14 of the movable mirror 41 is adjusted or determined so that the exit pupil E is formed at the identified position of the pupil 51.

In FIG. 10, the position of the pupil 51 is shifted in the −X-direction from the default position. The movable mirror 41 is tilted around the Y-axis as the rotation axis, to form the exit pupil E at the position of the pupil 51. The reflection direction of the light L1 reflected by the movable mirror 41 is shifted in the +Z-direction. The light L1 reflected by the movable mirror 41 is converted into collimated light by the concave mirror 42, reflected by the reflecting surface within the prism 6, and directed to the optical scanner 2. The light L2 scanned in two axial directions is subsequently reflected by the reflecting surface in the prism 6, passes through the second lens 31, is reflected by the fixed mirror 7, and then reaches the holographic optical element 32.

The holographic optical element 32 reflects the incoming light L2 toward the observer U's eyeball 50 while converging the light L2, forming an exit pupil E. In the eyepiece optical system 3, the area of the holographic optical element 32 on which light is incident changes according to the tilt angle of the reflecting surface 14 of the movable mirror 41, causing the exit pupil E to shift in the −X-direction. Thus, the center of the pupil 51 and the position of the exit pupil E are aligned or overlap. The light L2 reflected by the holographic optical elements 32 converges near the center of the pupil 51 before reaching the retina 52 of the observer U. The viewer U can visually recognize the image formed in the retina 52.

Light propagating in the −Z-direction from the object 70 in the real space is light having a wide wavelength band including a visible wavelength band. The holographic optical element 32 has excellent transmittance because the hologram works for a very narrow wavelength as compared to the wavelength band of visible light. Most of the light propagating from the real space toward the eyeball 50 of the observer U passes through the holographic optical element 32 and reaches the retina 52 of the observer U. Accordingly, the image of the object 70 in the real space is visually recognized with sufficient brightness. As described above, the observer U wearing the retinal projection display device 100 visually recognizes the image and the image of the object 70 in the real space in parallel, and visually recognizes both the image and the image of the real space in a bright state.

To avoid such a situation, the sensor 8 constantly monitors the position of the pupil 51 of the observer U in the retinal projection image display device 100. In the retinal projection image display device 100, the sensor 8 first identifies the position of the center of the pupil 51 when the observer U is viewing straight ahead. Then, the tilt angle of the reflecting surface 14 of the movable mirror 41 is adjusted to control image formation, positioning the exit pupil E at the identified position of the pupil 51. Thus, in general, the pupillary distance between both eyes varies among individuals, and among the observers U. However, regardless of where the pupil 51 is located, the observer U can immediately visually recognize an image within a predetermined finite angle of view when wearing the retinal projection image display device 100.

In the retinal projection image display device 100, the angle of view visible through the exit pupil E, formed when the observer U is looking straight ahead, is limited. When the position of the exit pupil E is fixed, if the observer U shifts the gaze beyond this finite angle of view, the image becomes obscured by the observer's pupil 51, causing the image to disappear. In the retinal projection image display device 100, when the observer U shifts the gaze beyond the limited angle of view visible through the exit pupil E formed when viewing straight ahead, the tilt angle of the reflecting surface 14 of the movable mirror 41 is controlled to adjust the position of the exit pupil E, aligning the exit pupil E with the pupil 51 of the observer U. This configuration allows the image to be constantly displayed in the gaze direction of the observer U, enabling the image displayed to follow the observer's eye movements. For example, if the image remains the same regardless of the movement of the line of sight, the retinal projection image display device 100 can consistently display the same image wherever the observer U looks. It is useful for tasks such as supporting manufacturing sites where information needs to be constantly displayed in the line of sight, as well as for general consumers to digitally check additional information about objects they are viewing in daily life.

Further, when different images are displayed within the field of view according to the movement of the observer's gaze, information or data intended for the observer can be preset to appear in the gaze direction. This allows the observer to confirm the information by simply shifting their gaze to the designated area within the field of view when needed. In other words, a visual experience that depends on the observer's intention to watch when the user wants to watch the video can be provided. Accordingly, in a case where the observer U is a manufacturing worker or an infrastructure inspection worker, the work in the real space is not hindered by a clear field of view, the digital content such as a work instruction can be favorably visually recognized only when the sight line is moved at a proper timing, and the work can be performed without visual stress by focus-free. Thus, the retinal projection image display device 100 offers a new added value by allowing anyone to easily enjoy high-quality visual content. This makes it a technology with broad potential applications, including educational support, surgical assistance, and daily life support.

In the retinal projection image display device 100, the eyepiece optical system 3 collimates the light L2 scanned by the optical scanner 2, converges the light L2 at different positions according to the incident position on the optical scanner 2, and forms exit pupils. Thus, even if the exit pupil E is moved by the movable mirror 41, the state of the light L2 remains unchanged, enabling consistent image quality across all provided fields of view.

In the retinal projection image display device 100, the surface of the support substrate 91 for the optical scanner 2 and the surface of the support substrate 102 for the movable mirror 41 are arranged in parallel via the prism 6, and are aligned parallel to the longitudinal direction of the temple 111. This allows the folded light guide structure to be made thin. In the retinal projection image display device 100, the exit pupil E can be moved in a two-dimensional direction, both horizontally and vertically, simply by controlling the drive voltage of the movable mirror 41, which includes a MEMS mirror. By combining the movable mirror 41 with image formation control, movement in the depth direction is also possible. This eliminates the need for mechanisms or devices that involves physical repositioning or movement. This allows control and operation to be completed within the temple 111 without altering the external appearance, enabling the retinal projection image display device 100 to be compactly built and allowing the spectacle-shaped support 11 to be designed in a smaller, more stylish form.

A retinal projection display device is described below. Identical names and reference signs as in the above-described embodiment represent identical or equivalent members or components, and detailed description thereof is appropriately omitted. This point is likewise applied to embodiments described later.

### Configuration of Retinal Projection Image Display

### Overall Configuration

FIG. 11 is a schematic top view of a retinal projection image display device 100a. The retinal projection image display device 100a primarily differs from the first embodiment described above in that retinal projection image display device 100a further includes a magnifying optical system 12, positioned between the optical scanner 2 and the eyepiece optical system 3, which enlarges the eye box by changing the incident position of light L2 from the optical scanner 2 onto the eyepiece optical system 3.

The size of the eye box in the retinal projection image display device 100a is determined by the effective diameter of the reflecting mirror 92a of the optical scanner 2 and the lateral magnification of the eyepiece optical system 3. Increasing the lateral magnification of the eyepiece optical system 3 to enlarge the eye box reduces the angle of view for image display, creating a trade-off. As a result, a design that balances the angle of view and the eye box size is preferred, but this involves a limitation.

In the present embodiment, the eye box is enlarged by adjusting the incident position of light L2, emitted from the optical scanner 2, on the eyepiece optical system 3 through the magnifying optical system 12. This achieves both an enlarged eye box and a wider angle of view.

In the retinal projection image display device 100a illustrated in FIG. 11, the light L2 incident on the magnifying optical system 12 from the optical scanner 2 is collimated light. With this configuration, even if the distances between the optical scanner 2 and the magnifying optical system 12 change, the incident angles of light L2 on the magnifying optical system 12 can remain consistent without affecting the eye box magnification capability.

The retinal projection image display device 100a illustrated in FIG. 11 has two magnifying optical systems 12 including a first magnifying optical system 12-1 and a second magnifying optical system 12-2. In the retinal projection image display device 100a, including two magnifying optical systems 12 allows for greater eye box magnification and a wider angle of view, than using a single magnifying optical system 12. The number of the magnifying optical systems 12 is not limited to two, and may be three or more. The magnification of the eye box and the angle of view increases according to the number of magnifying optical systems 12.

The retinal projection image display device 100a illustrated in FIG. 11 has a spectacle-shaped support 11 including a temple 111, and the multiple magnifying optical systems 12 are arranged on the temple 111 side by side in the extension direction in which the temple 111 extends. The extension direction in which the temple 111 extends is substantially orthogonal to the direction in which both eyes of the observer U, wearing the spectacle-shaped support 11, are aligned. In FIG. 11, the direction in which both eyes of the observer U wearing the spectacle-shaped support 11 are aligned corresponds to the X direction, and the direction substantially orthogonal to the direction in which the eyes are aligned corresponds to the Z direction. By arranging multiple magnifying optical systems 12 side by side along the extension direction in which the temple 111 extends, the temple 111 can be made thinner, and the retinal projection image display device 100a can be made more compact than arranging the magnifying optical systems in a direction substantially perpendicular to the extension direction in which the temple 111 extends. Multiple magnifying optical system 12 may be placed inside the temple 111 or on the surface of the temple 111.

In the retinal projection image display device 100a illustrated in FIG. 11, the first magnifying optical system 12-1 includes a first magnifying lens 13-1, a first magnifying prism 14-1, a first magnifying concave mirror 15-1, and a first magnifying movable mirror 16-1. The second magnifying optical system 12-2 includes a second magnifying lens 13-2, a second magnifying prism 14-2, a second magnifying concave mirror 15-2, and a second magnifying movable mirror 16-2. The controller 9 drives the first magnifying movable mirror 16-1 by outputting drive signal D4-1. The controller 9 outputs a drive signal D4-2 to drive the second magnifying movable mirror 16-2.

A vector scan MEMS mirror with the same configuration as the movable mirror 41 in FIG. 3 can be used for both the first magnifying movable mirror 16-1 and the second magnifying movable mirror 16-2. In FIG. 11, the first magnifying movable mirror 16-1 and the second magnifying movable mirror 16-2 are placed such that the surfaces of the support substrates 102 are parallel to the longitudinal direction of the temple 111. In this configuration, the surface of the support substrate 102 of the first magnifying movable mirror 16-1, the surface of the support substrate 102 of the second magnifying movable mirror 16-2, and the surface of the support substrate 91 of the optical scanner 2 can be positioned flush with one another. As a result, the first magnifying movable mirror 16-1, the second magnifying movable mirror 16-2, and the optical scanner 2 can be mounted on, for example, a common circuit board.

The first magnifying optical system 12-1 includes the first magnifying prism 14-1, allowing the light-guiding structure and the first magnifying optical system 12-1 itself to be miniaturized. The second magnifying optical system 12-2 includes the second magnifying prism 14-2, allowing the light-guiding structure and the second magnifying optical system 12-2 itself to be miniaturized. However, the configuration of the magnifying optical system 12 is not limited to including the first magnifying prism 14-1 and the second magnifying prism 14-2, and can be changed as needed according to the specifications of the retinal projection image display device 100a.

The first magnifying movable mirror 16-1 and the second magnifying movable mirror 16-2 are not limited to vector scan MEMS mirrors, and may be two single-axis MEMS mirrors. However, using vector scan MEMS mirrors for the first magnifying movable mirrors 16-1 and the second magnifying movable mirror 16-2 can reduce the size and weight of the retinal projection image display device 100a. Further, the first magnifying movable mirror 16-1 and the second magnifying movable mirror 16-2 may be configured to use one uniaxial MEMS mirror. In this case, the direction of enlargement of the eye box is limited to one dimension.

### Moving Operation of Exit Pupil E in Retinal Projection Image Display Device 100a

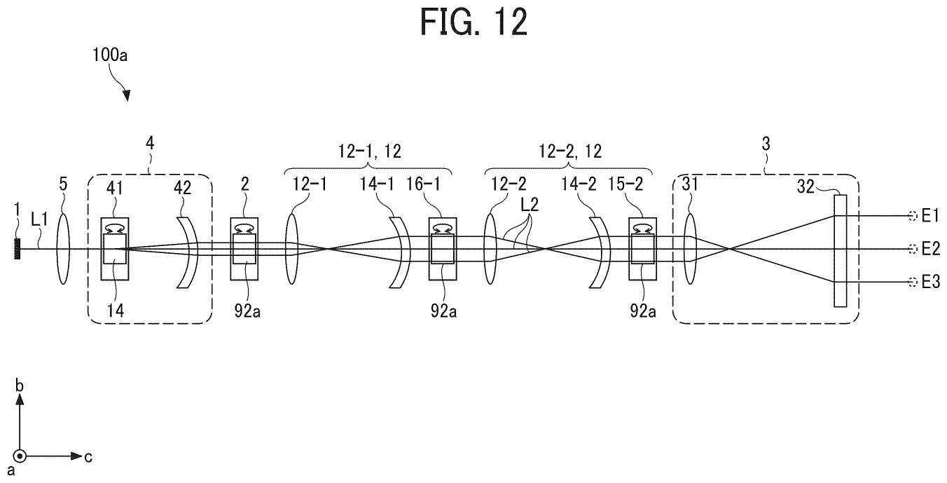

FIG. 12 is a schematic diagram illustrating the movement of the exit pupil E in the retinal projection image display device 100a.

FIG. 12 illustrates a simplified configuration for moving the exit pupil E in the retinal projection image display device 100a in FIG. 11, with the principal rays of the light L1 and the light L2 passing through the retinal projection image display device 100a represented as straight lines.

In FIG. 12, the passage position of the light L1 on the image side of the first magnifying optical system 12-1 shifts in the b-direction according to the tilt angle of the reflecting surface 14 of the movable mirror 41. As a result, the incident position of light L1 on the reflecting surface 14 of the first magnifying movable mirror 16-1 varies according to the tilt angle of the reflecting surface 14 of the movable mirror 41. The light L1 received from the first magnifying optical system 12-1 falls within the effective diameter of the reflecting surface 14 of the first magnifying movable mirror 16-1. The tilt angle control range of the reflecting surface 14 of the movable mirror 41 and the lateral magnification of the first magnifying optical system 12-1 are restricted by the incidence range on the effective diameter of the reflecting surface 14 of the first magnifying movable mirror 16-1. However, the tilt angle control range and lateral magnification can still be freely selected within these limits.

In FIG. 12, the second magnifying optical system 12-2 has a lateral magnification of 1. Since the lateral magnification of the second magnifying optical system 12-2 is 1, changes in the tilt angle of the reflecting surface 14 of the first magnifying movable mirror 16-1 do not affect the incident position of light L1 on the second magnifying movable mirror 16-2, which remains the same as on the first magnifying movable mirror 16-1. However, the light L2 scanned by the optical scanner 2 can enter from a different direction. The effective diameter of the reflecting surface 14 of the second magnifying movable mirror 16-2 is determined so that the light L2 received from the second magnifying optical system 12-2 is fully contained within the effective diameter of the reflecting surface 14 of the second magnifying movable mirror 16-2.

In FIG. 12, the eyepiece optical system 3 has a lateral magnification of four, for example. The size of the eye box formed by the retinal projection image display device 100a is determined by the effective diameter of the reflecting surface 14 of the second magnifying movable mirror 16-2, as well as by the lateral magnification of the eyepiece optical system 3. For example, when the effective diameter of the reflecting surface 14 of the second magnifying movable mirror 16-2 is 2 mm, the size of the eye box is 8 mm. As described above, in the retinal projection image display device 100a, the final size of the eye box can be defined by the relationship between the tilt angle control range of the reflecting surface 14 of the movable mirror 41, the lateral magnification of the first magnifying optical system 12-1, and the lateral magnification of the eyepiece optical system 3. The incident position of the light L2 emitted from the optical scanner 2 onto the eyepiece optical system 3 corresponds to its incident position on the second lens 31.

The retinal projection image display device 100a can also move the exit pupil E in the a-direction by tilting the reflecting surface 14 of the movable mirror 41 around the b-axis as the rotation axis. In the retinal projection image display device 100a, the exit pupil E can be moved within the size of the eye box in any desired manner, simply by controlling the tilt angle of the reflecting surface 14 of the movable mirror 41.

The retinal projection image display device 100a includes a first magnifying optical system 12-1 and a second magnifying optical system 12-2, in addition to the variable optical system 4 for controlling the exit pupils E. The first magnifying optical system 12-1 and the second magnifying optical system 12-2 are placed between the optical scanner 2 and the eyepiece optical system 3. The first magnifying optical system 12-1 and the second magnifying optical system 12-2 serve to move the position of the image displayed within the field of view of the observer U as well as enlarge the angle of view of light L2 scanned b the optical scanner 2. In other words, the incident angle of the light L2 entering the eyeball 50 of the observer U can be changed. Although the angle of view of the image formed by the optical scanner 2 is fixed, the position at which the image can be displayed within the field of view of the observer U can be freely adjusted or changed. This allows the image to follow the observer's gaze without any vignetting caused by eye movement.

The retina projection method has a disadvantage in which a viewing zone is narrow due to a characteristic in which an image is once focused on a pupil. To overcome this disadvantage and allow the observer U to enjoy a stress-free visual experience using retinal projection, it is preferable to accommodate individual differences in interpupillary distance, eliminate vignetting due to gaze shift, and allow for free adjustment of image position in response to eye movement. However, no exiting technology fully meet all of these requirements. In the present embodiment, all of these features can be achieved, allowing anyone to wear the device and immediately experience projection synchronized with eye movement, without vignetting caused by gaze shifts, without a need to select a specific observer U.

### An Optometric Device is Described Below.

The retinal projection image display device 100 and the retinal projection image display device 100a described above can also be applied to an optometric device. The optometric device refers to a device to perform various examinations such as visual acuity test, ocular refraction test, intraocular pressure test, and axial length test. The optometric device is a non-contact apparatus for examining the eye, equipped with a support portion to hold the subject's face, an examination window, a display unit for projecting examination information onto the subject's eye during the examination, a controller, and a measurement unit. The subject fixates his or her face to a supporting section, and gazes at the test information projected by a display unit through the optometric window. At this time, since the eyeball position and the optimal projection direction for easy visual recognition differ for each subject, the optical device of the present embodiment can be used as the display unit. Further, using the retinal projection image display device 100 and the retinal projection image display device 100a achieve an eyeglass optometric device. The optometric apparatus in the form of glasses eliminates the needs for space and a large-sized optometric apparatus for examination, and enables examination with a simple configuration without being affected by a place.

In addition, when there is need to gaze at one point without moving the eyeball (gaze) to increase the measurement accuracy of the measurement unit, measurement can be performed based on the pupil position information of the eyeball 50. This is achieved by feeding back the information on the position of the pupil 51 or the cornea of the eyeball 50 obtained by the sensor 8 to the controller 9.

Although the desirable embodiments have been described in detail, the disclosure is not limited to the above-described embodiments, and various modifications and substitutions can be made on the embodiments without departing from the scope of the disclosure as set forth in the appended claims.

Aspects of the present disclosure are, for example, as follows.

### Aspect 1

A retina projection image display device includes: a light source to emit light; an optical scanner to scan the light emitted from the light source, to form an image with the scanned light; an eyepiece optical system to guide an exit pupil of the light scanned by the optical scanner to an eyeball; and a variable optical system between the light source and the optical scanner. The variable optical system includes: a light collimator to convert the light emitted from the light source into collimated light which is directed to the optical scanner; and a movable mirror with a variable tilt to change a reflection angle of the light emitted from the light source to the optical scanner to change an incident position of the light emitted from the light source onto the optical scanner to shift the exit pupil.

### Aspect 2

In the retina projection image display device according to Aspect 1, the light collimator includes a concave mirror.

### Aspect 3

The retina projection image display device according to Aspect 1, further includes: circuitry configured to move the movable mirror so that the optical scanner changes the incident position of the light emitted from the light source onto the optical scanner to shift the exit pupil.

### Aspect 4

The retina projection image display device according to any one of Aspects 1 to 3, further includes: a spectacle-shaped support including a temple extending in an extension direction, the temple including the optical scanner and the variable optical system extending along the extension direction.

### Aspect 5

In the retina projection image display device according to Aspect 4, the optical scanner has a first optical scanning surface. The variable optical system has a second optical scanning surface. The first optical scanning surface and the second optical scanning surface are positioned facing each other during non-operation of the optical scanner and the variable optical system.

### Aspect 6

In the retina projection image display device according to any one of Aspects 1 to 5, the eyepiece optical system faces the eyeball; and includes a holographic optical element to converge and reflect the light scanned by the optical scanner to the eyeball.

### Aspect 7

The retina projection image display device according to any one of Aspects 1 to 6, further includes: a magnifying optical system between the optical scanner and the eyepiece optical system, the magnifying optical system to change the incident position of the light emitted from the optical scanner onto the eyepiece optical system, to enlarge an eye box.

### Aspect 8

In the retina projection image display device according to Aspect 7, the magnifying optical system receives collimated light from the optical scanner.

### Aspect 9

The retina projection image display device according to Aspect 7, further includes multiple magnifying optical systems including the magnifying optical system.

### Aspect 10

The retina projection image display device according to Aspect 9, further includes a spectacle-shaped support including a temple extending in an extension direction, the temple including multiple magnifying optical systems extending along the extension direction.

### Aspect 11

The retina projection image display device according to any one of Aspects 1 to 10, further includes: a sensor to detect a position of a pupil or a cornea. The circuitry is configured to move the movable mirror controls the optical scanner and the variable optical system according to the position of the pupil or the cornea detected by the sensor.

### Aspect 12

In the retina projection image display device according to Aspect 11, the sensor includes another light source; and a photosensor to receive light emitted from said another sensor and reflected from the eyeball and output information on a light receiving position of the light received on the sensor, and the optical scanner scans the light emitted from said another light source into the eyeball.

### Aspect 13

A retina projection image display device includes a light source to emit light; an optical scanner to scan the light emitted from the light source, to form an image with the scanned light; an eyepiece optical system to guide an exit pupil of the light scanned by the optical scanner to an eyeball; a sensor to detect a position of a pupil or a cornea of the eyeball, a variable optical system between the light source and the optical scanner; and circuitry. The variable optical system includes a light collimator to convert the light emitted from the light source into collimated light which is directed to the optical scanner, and a movable mirror with a variable tilt to change a reflection angle of the light emitted from the light source to the optical scanner to change an incident position of the light emitted from the light source onto the optical scanner to shift the exit pupil. The circuitry is configured to control the optical scanner and the variable optical system according to the position of the pupil or the cornea detected by the sensor.

### Aspect 14

A retina projection image display device includes a light source to emit light; an optical scanner to scan the light emitted from the light source, to form an image with the scanned light; an eyepiece optical system to guide an exit pupil of the light scanned by the optical scanner to an eyeball; and a variable optical system between the light source and the optical scanner, to change an incident position of the light emitted from the light source onto the optical scanner to shift the exit pupil.

Numerals such as ordinal numbers and numerical values used in the description of the embodiments are examples for specifically describing the technology of the disclosure, and the disclosure is not limited by the exemplified numerals. The connection relationship between the components is an example for specifically describing the technology of the disclosure, and the connection relationship that implements the functions of the disclosure is not limited thereto.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A retina projection image display device, comprising:
a light source to emit light;
an optical scanner to scan the light emitted from the light source, to form an image with the scanned light;
an eyepiece optical system to guide an exit pupil of the light scanned by the optical scanner to an eyeball; and
a variable optical system between the light source and the optical scanner, the variable optical system including:
a light collimator to convert the light emitted from the light source into collimated light which is directed to the optical scanner; and
a movable mirror with a variable tilt to change a reflection angle of the light emitted from the light source to the optical scanner to change an incident position of the light emitted from the light source onto the optical scanner to shift the exit pupil.

2. The retina projection image display device according to claim 1, wherein:
the light collimator includes a concave mirror.

3. The retina projection image display device according to claim 1, further comprising:
circuitry configured to move the movable mirror so that the optical scanner changes the incident position of the light emitted from the light source onto the optical scanner to shift the exit pupil.

4. The retina projection image display device according to claim 1, further comprising:
a spectacle-shaped support including a temple extending in an extension direction, the temple including the optical scanner and the variable optical system extending along the extension direction.

5. The retina projection image display device according to claim 4, wherein:
the optical scanner has a first optical scanning surface,
the variable optical system has a second optical scanning surface,
the first optical scanning surface and the second optical scanning surface are positioned facing each other during non-operation of the optical scanner and the variable optical system.

6. The retina projection image display device according to claim 1, wherein the eyepiece optical system:
faces the eyeball; and
includes a holographic optical element to converge and reflect the light scanned by the optical scanner to the eyeball.

7. The retina projection image display device according to claim 1, further comprising:
a magnifying optical system between the optical scanner and the eyepiece optical system, the magnifying optical system to change the incident position of the light emitted from the optical scanner onto the eyepiece optical system, to enlarge an eye box.

8. The retina projection image display device according to claim 7, wherein:
the magnifying optical system receives collimated light from the optical scanner.

9. The retina projection image display device according to claim 7, further comprising:
multiple magnifying optical systems including the magnifying optical system.

10. The retina projection image display device according to claim 9, further comprising:
a spectacle-shaped support including a temple extending in an extension direction, the temple including multiple magnifying optical systems extending along the extension direction.

11. The retina projection image display device according to claim 3, further comprising:
a sensor to detect a position of a pupil or a cornea,
wherein the circuitry configured to move the movable mirror controls the optical scanner and the variable optical system according to the position of the pupil or the cornea detected by the sensor.

12. The retina projection image display device according to claim 11,
wherein the sensor includes:
another light source; and
a photosensor to receive light emitted from said another sensor and reflected from the eyeball and output information on a light receiving position of the light received on the sensor, and
the optical scanner scans the light emitted from said another light source into the eyeball.

13. A retina projection image display device, comprising:
a light source to emit light;
an optical scanner to scan the light emitted from the light source, to form an image with the scanned light;
an eyepiece optical system to guide an exit pupil of the light scanned by the optical scanner to an eyeball;
a sensor to detect a position of a pupil or a cornea of the eyeball,
a variable optical system between the light source and the optical scanner, the variable optical system including:
a light collimator to convert the light emitted from the light source into collimated light which is directed to the optical scanner, and
a movable mirror with a variable tilt to change a reflection angle of the light emitted from the light source to the optical scanner to change an incident position of the light emitted from the light source onto the optical scanner to shift the exit pupil; and
circuitry configured to control the optical scanner and the variable optical system according to the position of the pupil or the cornea detected by the sensor.

14. The retina projection image display device according to claim 13, wherein:
the light collimator includes a concave mirror.

15. The retina projection image display device according to claim 13, further comprising:
a spectacle-shaped support including a temple extending in an extension direction, the temple including the optical scanner and the variable optical system extending along the extension direction.

16. The retina projection image display device according to claim 15, wherein:
the optical scanner has a first optical scanning surface,
the variable optical system has a second optical scanning surface,
the first optical scanning surface and the second optical scanning surface are positioned facing each other during non-operation of the optical scanner and the variable optical system.

17. The retina projection image display device according to claim 13, wherein the eyepiece optical system:
faces the eyeball; and
includes a holographic optical element to converge and reflect the light scanned by the optical scanner to the eyeball.

18. The retina projection image display device according to claim 13, further comprising:
a magnifying optical system between the optical scanner and the eyepiece optical system, the magnifying optical system to change the incident position of the light emitted from the optical scanner onto the eyepiece optical system, to enlarge an eye box.

19. The retina projection image display device according to claim 18, wherein:
the magnifying optical system receives collimated light from the optical scanner.

20. A retina projection image display device, comprising:
a light source to emit light;
an optical scanner to scan the light emitted from the light source, to form an image with the scanned light;
an eyepiece optical system to guide an exit pupil of the light scanned by the optical scanner to an eyeball; and
a variable optical system between the light source and the optical scanner, to change an incident position of the light emitted from the light source onto the optical scanner to shift the exit pupil.
